(19) United States
(12) Patent Application Publication
(10) Pub. No.: US 2026/0230650 A1
(43) Pub. Date: Aug. 6, 2026

(54) Method and Apparatus of Transform Selection Depending on Intra Prediction Mode in Video Coding System

(71) Applicant: MEDIATEK INC., Hsinchu City (TW)

(72) Inventors: Man-Shu CHIANG, Hsinchu City (TW); Chih-Wei HSU, Hsinchu City (TW); Tzu-Der CHUANG, Hsinchu City (TW); Ching-Yeh CHEN, Hsinchu City (TW)

(21) Appl. No.: 19/157,525

(22) PCT Filed: Feb. 1, 2024
(86) PCT No.: PCT/CN2024/075180

§ 371 Date: Aug. 18, 2025

Related U.S. Application Data
(60) Provisional application No. 63/486,675, filed on Feb. 24, 2023.
(60) Provisional application No. 63/486,676, filed on Feb. 24, 2023.
(60) Provisional application No. 63/488,206, filed on Mar. 3, 2023.

(51) Int. Cl. H04N 19/61; H04N 19/109; H04N 19/11; H04N 19/12; H04N 19/176; H04N 19/186

(52) U.S. Cl. CPC H04N 19/61; H04N 19/109; H04N 19/11; H04N 19/12; H04N 19/176; H04N 19/186

(57) ABSTRACT

A method and apparatus for video coding. According to this method, input data associated with a current block are received, wherein the input data comprise residual data to be processed at an encoder side or coded transform data associated with the current block to be decoded at a decoder side. Transform process is applied to the input data, wherein the transform process determines a target transform for the current block. The target transform is selected from a transform candidate set including at least one additional transform candidate with respect to an original transform candidate set or the target transform is determined depending on an intra prediction mode associated with the current block, a reference region, or one or more neighbouring blocks. Transformed output is provided, wherein the transformed output comprises transform coefficients of the current block at the encoder side or recovered residual data at the decoder side.

### CROSS REFERENCE TO RELATED APPLICATIONS

The present invention is a non-Provisional Application of and claims priority to U.S. Provisional Patent Application No. 63/486,675, filed on Feb. 24, 2023, U.S. Provisional Patent Application No. 63/486,676, filed on Feb. 24, 2023, and U.S. Provisional Patent Application No. 63/488,206, filed on Mar. 3, 2023. The U.S. Provisional patent applications are hereby incorporated by reference in their entireties.

### FIELD OF THE INVENTION

The present invention relates to video coding system. In particular, the present invention relates to schemes to improve the transform process by including additional transform candidates and/or applying the transform process depending on the intra prediction mode associated with the current block, a reference region, or one or more neighbouring blocks.

### BACKGROUND AND RELATED ART

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology—Coded representation of immersive media—Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video encoding system incorporating loop processing. For Intra Prediction, the prediction data is derived based on previously coded video data in the current picture. For Inter Prediction 112, Motion Estimation (ME) is performed at the encoder side and Motion Compensation (MC) is performed based on the result of ME to provide prediction data derived from other picture(s) and motion data. Switch 114 selects Intra Prediction 110 or Inter-Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, are provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

According to VVC, an input picture is partitioned into non-overlapped square block regions referred as CTUs (Coding Tree Units), similar to HEVC. Each CTU can be partitioned into one or multiple smaller size coding units (CUs). The resulting CU partitions can be in square or rectangular shapes. Also, VVC divides a CTU into prediction units (PUs) as a unit to apply prediction process, such as Inter prediction, Intra prediction, etc.

### Partitioning of the CTUs Using a Tree Structure

In HEVC, a CTU is split into CUs by using a quaternary-tree (QT) structure denoted as coding tree to adapt to various local characteristics. The decision whether to code a picture area using inter-picture (temporal) or intra-picture (spatial) prediction is made at the leaf CU level. Each leaf CU can be further split into one, two or four PUs according to the PU splitting type. Inside one PU, the same prediction process is applied and the relevant information is transmitted to the decoder on a PU basis. After obtaining the residual block by applying the prediction process based on the PU splitting type, a leaf CU can be partitioned into transform units (TUs) according to another quaternary-tree structure similar to the coding tree for the CU. One of key feature of the HEVC structure is that it has the multiple partition conceptions including CU, PU, and TU.

In VVC, a quadtree with nested multi-type tree using binary and ternary splits segmentation structure replaces the concepts of multiple partition unit types, i.e. it removes the separation of the CU, PU and TU concepts except as needed for CUs that have a size too large for the maximum transform length, and supports more flexibility for CU partition shapes. In the coding tree structure, a CU can have either a square or rectangular shape. A coding tree unit (CTU) is first partitioned by a quaternary tree (a.k.a. quadtree) structure. Then the quaternary tree leaf nodes can be further partitioned by a multi-type tree structure. As shown in FIG. 2, there are four splitting types in multi-type tree structure, vertical binary splitting (SPLIT_BT_VER 210), horizontal binary splitting (SPLIT_BT_HOR 220), vertical ternary splitting (SPLIT_TT_VER 230), and horizontal ternary splitting (SPLIT_TT_HOR 240). The multi-type tree leaf nodes are called coding units (CUs), and unless the CU is too large for the maximum transform length, this segmentation is used for prediction and transform processing without any further partitioning. This means that, in most cases, the CU, PU and TU have the same block size in the quadtree with nested multi-type tree coding block structure. The exception occurs when maximum supported transform length is smaller than the width or height of the colour component of the CU.

FIG. 3 illustrates the signalling mechanism of the partition splitting information in quadtree with nested multi-type tree coding tree structure. A coding tree unit (CTU) is treated as the root of a quaternary tree and is first partitioned by a quaternary tree structure. Each quaternary tree leaf node (when sufficiently large to allow it) is then further partitioned by a multi-type tree structure. In quadtree with nested multi-type tree coding tree structure, for each CU node, a first flag (split_cu_flag) is signalled to indicate whether the node is further partitioned. If the current CU node is a quadtree CU node, a second flag (split_qt_flag) whether it's a QT partitioning or MTT partitioning mode. When a node is partitioned with MTT partitioning mode, a third flag (mtt_split_cu_vertical_flag) is signalled to indicate the splitting direction, and then a fourth flag (mtt_split_cu_binary_flag) is signalled to indicate whether the split is a binary split or a ternary split. Based on the values of mtt_split_cu_vertical_flag and mtt_split_cu_binary_flag, the multi-type tree slitting mode (MttSplitMode) of a CU is derived as shown in Table 1.

TABLE 1
MttSplitMode derivation based on multi-type tree syntax elements

| MttSplitMode | mtt_split_cu_vertical_flag | mtt_split_cu_binary_flag |
|---|---|---|
| SPLIT_TT_HOR | 0 | 0 |
| SPLIT_BT_HOR | 0 | 1 |
| SPLIT_TT_VER | 1 | 0 |
| SPLIT_BT_VER | 1 | 1 |

FIG. 4 shows a CTU divided into multiple CUs with a quadtree and nested multi-type tree coding block structure, where the bold block edges represent quadtree partitioning and the remaining edges represent multi-type tree partitioning. The quadtree with nested multi-type tree partition provides a content-adaptive coding tree structure comprised of CUs. The size of the CU may be as large as the CTU or as small as 4×4 in units of luma samples. For the case of the 4:2:0 chroma format, the maximum chroma CB size is 64×64 and the minimum size chroma CB consist of 16 chroma samples.

In VVC, the maximum supported luma transform size is 64×64 and the maximum supported chroma transform size is 32×32. When the width or height of the CB is larger the maximum transform width or height, the CB is automatically split in the horizontal and/or vertical direction to meet the transform size restriction in that direction.

The following parameters are defined for the quadtree with nested multi-type tree coding tree scheme. These parameters are specified by SPS syntax elements and can be further refined by picture header syntax elements.
CTU size: the root node size of a quaternary tree
MinQTSize: the minimum allowed quaternary tree leaf node size
MaxBtSize: the maximum allowed binary tree root node size
MaxTtSize: the maximum allowed ternary tree root node size
MaxMttDepth: the maximum allowed hierarchy depth of multi-type tree splitting from a quadtree leaf
MinCbSize: the minimum allowed coding block node size

In one example of the quadtree with nested multi-type tree coding tree structure, the CTU size is set as 128×128 luma samples with two corresponding 64×64 blocks of 4:2:0 chroma samples, the MinQTSize is set as 16×16, the MaxBtSize is set as 128×128 and MaxTtSize is set as 64×64, the MinCbsize (for both width and height) is set as 4×4, and the MaxMttDepth is set as 4. The quaternary tree partitioning is applied to the CTU first to generate quaternary tree leaf nodes. The quaternary tree leaf nodes may have a size from 16×16 (i.e., the MinQTSize) to 128×128 (i.e., the CTU size). If the leaf QT node is 128×128, it will not be further split by the binary tree since the size exceeds the MaxBtSize and MaxTtSize (i.e., 128×128). Otherwise, the leaf qdtree node could be further partitioned by the multi-type tree. Therefore, the quaternary tree leaf node is also the root node for the multi-type tree and it has multi-type tree depth (mttDepth) as 0. When the multi-type tree depth reaches MaxMttDepth (i.e., 4), no further splitting is considered. When the multi-type tree node has width equal to MinCbsize, no further horizontal splitting is considered. Similarly, when the multi-type tree node has height equal to MinCbsize, no further vertical splitting is considered.

In VVC, the coding tree scheme supports the ability for the luma and chroma to have a separate block tree structure. For P and B slices, the luma and chroma CTBs in one CTU have to share the same coding tree structure. However, for I slices, the luma and chroma can have separate block tree structures. When the separate block tree mode is applied, luma CTB is partitioned into CUs by one coding tree structure, and the chroma CTBs are partitioned into chroma CUs by another coding tree structure. This means that a CU in an I slice may consist of a coding block of the luma component or coding blocks of two chroma components, and a CU in a P or B slice always consists of coding blocks of all three colour components unless the video is monochrome.

### Virtual Pipeline Data Units (VPDUs)

Virtual pipeline data units (VPDUs) are defined as non-overlapping units in a picture. In hardware decoders, successive VPDUs are processed by multiple pipeline stages at the same time. The VPDU size is roughly proportional to the buffer size in most pipeline stages, so it is important to keep the VPDU size small. In most hardware decoders, the VPDU size can be set to maximum transform block (TB) size. However, in VVC, ternary tree (TT) and binary tree (BT) partition may lead to the increasing of VPDUs size.

In order to keep the VPDU size as 64×64 luma samples, the following normative partition restrictions (with syntax signalling modification) are applied in VTM, as shown in FIG. 5:
TT split is not allowed (as indicated by “X” in FIG. 5) for a CU with either width or height, or both width and height equal to 128.
For a 128×N CU with N≤64 (i.e. width equal to 128 and height smaller than 128), horizontal BT is not allowed.
For an N×128 CU with N≤64 (i.e. height equal to 128 and width smaller than 128), vertical BT is not allowed.

In FIG. 5, the luma block size is 128×128. The dashed lines indicate block size 64×64. According to the constraints mentioned above, examples of the partitions not allowed are indicated by “X” as shown in various examples (510-580) in FIG. 5.

Intra Mode Coding with 67 Intra Prediction Modes

To capture the arbitrary edge directions presented in natural video, the number of directional intra modes in VVC is extended from 33, as used in HEVC, to 65. The new directional modes not in HEVC are depicted as dotted arrows in FIG. 6, and the planar and DC modes remain the same. These denser directional intra prediction modes apply for all block sizes and for both luma and chroma intra predictions.

In VVC, several conventional angular intra prediction modes are adaptively replaced with wide-angle intra prediction modes for the non-square blocks.

In HEVC, every intra-coded block has a square shape and the length of each of its side is a power of 2. Thus, no division operations are required to generate an intra-predictor using DC mode. In VVC, blocks can have a rectangular shape that necessitates the use of a division operation per block in the general case. To avoid division operations for DC prediction, only the longer side is used to compute the average for non-square blocks.

To keep the complexity of the most probable mode (MPM) list generation low, an intra mode coding method with 6 MPMs is used by considering two available neighbouring intra modes. The following three aspects are considered to construct the MPM list:
Default intra modes
Neighbouring intra modes
Derived intra modes.

A unified 6-MPM list is used for intra blocks irrespective of whether MRL and ISP coding tools are applied or not. The MPM list is constructed based on intra modes of the left and above neighbouring block. Suppose the mode of the left is denoted as Left and the mode of the above block is denoted as Above, the unified MPM list is constructed as follows:
When a neighbouring block is not available, its intra mode is set to Planar by default.
If both modes Left and Above are non-angular modes:
   MPM list→{Planar, DC, V, H, V−4, V+4}
If one of modes Left and Above is angular mode, and the other is non-angular:
   Set a mode Max as the larger mode in Left and Above
   MPM list→{Planar, Max, Max−1, Max+1, Max−2, M+2}
If Left and Above are both angular and they are different:
   Set a mode Max as the larger mode in Left and Above
   If Max−Min is equal to 1:
      MPM list→{Planar, Left, Above, Min−1, Max+1, Min−2}
   Otherwise, if Max-Min is greater than or equal to 62:
      MPM list→{Planar, Left, Above, Min+1, Max−1, Min+2}
   Otherwise, if Max-Min is equal to 2:
      MPM list→{Planar, Left, Above, Min+1, Min−1, Max+1}
   Otherwise:
      MPM list→{Planar, Left, Above, Min−1, −Min+1, Max−1}
If Left and Above are both angular and they are the same:
   MPM list→{Planar, Left, Left−1, Left+1, Left−2, Left+2}

Besides, the first bin of the MPM index codeword is CABAC context coded. In total three contexts are used, corresponding to whether the current intra block is MRL enabled, ISP enabled, or a normal intra block.

During 6 MPM list generation process, pruning is used to remove duplicated modes so that only unique modes can be included into the MPM list. For entropy coding of the 61 non-MPM modes, a Truncated Binary Code (TBC) is used.

Secondary MPM lists is introduced as described in JVET-D0114 (Seregin, et al., “Block shape dependent intra mode coding”, Joint Video Exploration Team (JVET) of ITU-T SG 16 WP 3 and ISO/IEC JTC 1/SC 29/WG 11, 4th Meeting: Chengdu, CN, 15-21 Oct. 2016, Document JVET-D0114). The existing primary MPM (PMPM) list consists of 6 entries and the secondary MPM (SMPM) list includes 16 entries. A general MPM list with 22 entries is constructed first, and then the first 6 entries in this general MPM list are included into the PMPM list, and the rest of entries form the SMPM list. The first entry in the general MPM list is the Planar mode. The remaining entries are composed of the intra modes of the left (L), above (A), below-left (BL), above-right (AR), and above-left (AL) neighbouring blocks as shown in the following, the directional modes with added offset from the first two available directional modes of neighbouring blocks, and the default modes.

If a CU block is vertically oriented, the order of neighbouring blocks is A, L, BL, AR, AL; otherwise, it is L, A, BL, AR, AL. FIG. 7 illustrates the locations of the neighbouring blocks (L, A, BL, AR, AL) used in the derivation of a general MPM list for a current block 710.

A PMPM flag is parsed first, if equal to 1 then a PMPM index is parsed to determine which entry of the PMPM list is selected, otherwise the SPMPM flag is parsed to determine whether to parse the SMPM index or the remaining modes.

### Wide-Angle Intra Prediction for Non-Square Blocks

Conventional angular intra prediction directions are defined from 45 degrees to −135 degrees in clockwise direction. In VVC, several conventional angular intra prediction modes are adaptively replaced with wide-angle intra prediction modes for non-square blocks. The replaced modes are signalled using the original mode indexes, which are remapped to the indexes of wide angular modes after parsing. The total number of intra prediction modes is unchanged, i.e., 67, and the intra mode coding method is unchanged.

To support these prediction directions, the top reference with length 2W+1, and the left reference with length 2H+1, are defined as shown in FIG. 8A and FIG. 8B respectively.

The number of replaced modes in wide-angular direction mode depends on the aspect ratio of a block. The replaced intra prediction modes are illustrated in Table 2.

TABLE 2
Intra prediction modes replaced by wide-angular modes

| Aspect ratio | Replaced intra prediction modes |
|---|---|
| W/H == 16 | Modes 12, 13, 14, 15 |
| W/H == 8 | Modes 12, 13 |
| W/H == 4 | Modes 2, 3, 4, 5, 6, 7, 8, 9, 10, 11 |
| W/H == 2 | Modes 2, 3, 4, 5, 6, 7, |
| W/H == 1 | None |
| W/H == ½ | Modes 61, 62, 63, 64, 65, 66 |
| W/H == ¼ | Mode 57, 58, 59, 60, 61, 62, 63, 64, 65, 66 |
| W/H == ⅛ | Modes 55, 56 |
| W/H == 1/16 | Modes 53, 54, 55, 56 |

In VVC, 4:2:2 and 4:4:4 chroma formats are supported as well as 4:2:0. Chroma derived mode (DM) derivation table for 4:2:2 chroma format was initially ported from HEVC extending the number of entries from 35 to 67 to align with the extension of intra prediction modes. Since HEVC specification does not support prediction angle below −135° and above 45°, luma intra prediction modes ranging from 2 to 5 are mapped to 2. Therefore, chroma DM derivation table for 4:2:2: chroma format is updated by replacing some values of the entries of the mapping table to convert prediction angle more precisely for chroma blocks.

### Decoder Side Intra Mode Derivation (DIMD)

When DIMD is applied, two intra modes are derived from the reconstructed neighbour samples, and those two predictors are combined with the planar mode predictor with the weights derived from the gradients. The DIMD mode is used as an alternative prediction mode and is always checked in the high-complexity RDO mode.

To implicitly derive the intra prediction modes of a blocks, a texture gradient analysis is performed at both the encoder and decoder sides. This process starts with an empty Histogram of Gradient (HoG) with 65 entries, corresponding to the 65 angular modes. Amplitudes of these entries are determined during the texture gradient analysis.

In the first step, DIMD picks a template of T=3 columns and lines from respectively left side and above side of the current block. This area is used as the reference for the gradient based intra prediction modes derivation.

In the second step, the horizontal and vertical Sobel filters are applied on all 3×3 window positions, centred on the pixels of the middle line of the template. At each window position, Sobel filters calculate the intensity of pure horizontal and vertical directions as Gₓ and G_{y}, respectively. Then, the texture angle of the window is calculated as:

$$angle = arctan ( {G}_{x} / {G}_{y} ) , \qquad ( 1 )$$

which can be converted into one of 65 angular intra prediction modes. Once the intra prediction mode index of current window is derived as idx, the amplitude of its entry in the HoG[idx] is updated by addition of:

$$ampl = \vert {G}_{x} \vert + \vert {G}_{y} \vert \qquad ( 2 )$$

FIGS. 9A-C show an example of HoG, calculated after applying the above operations on all pixel positions in the template. FIG. 9A illustrates an example of selected template 920 for a current block 910. Template 920 comprises T lines above the current block and T columns to the left of the current block. For intra prediction of the current block, the area 930 at the above and left of the current block corresponds to a reconstructed area and the area 940 below and at the right of the block corresponds to an unavailable area. FIG. 9B illustrates an example for T=3 and the HoGs are calculated for pixels 960 in the middle line and pixels 962 in the middle column. For example, for pixel 952, a 3×3 window 950 is used. FIG. 9C illustrates an example of the amplitudes (ampl) calculated based on equation (2) for the angular intra prediction modes as determined from equation (1).

Once HoG is computed, the indices with two tallest histogram bars are selected as the two implicitly derived intra prediction modes for the block and are further combined with the Planar mode as the prediction of DIMD mode. The prediction fusion is applied as a weighted average of the above three predictors. To this aim, the weight of planar is fixed to 21/64 (~⅓). The remaining weight of 43/64 (~⅔) is then shared between the two HoG IPMs, proportionally to the amplitude of their HoG bars. FIG. 10 illustrates an example of the blending process. As shown in FIG. 10, two intra modes (M1 1012 and M2 1014) are selected according to the indices with two tallest bars of histogram bars 1010. The three predictors (1040, 1042 and 1044) are used to form the blended prediction. The three predictors correspond to applying the M1, M2 and planar intra modes (1020, 1022 and 1024 respectively) to the reference pixels 1030 to form the respective predictors. The three predictors are weighted by respective weighting factors (ω₁, ω₂ and ω₃) 1050. The weighted predictors are summed using adder 1052 to generated the blended predictor 1060. Note that, if only one mode (i.e., single mode) exists in the histogram, then no blending process, and no second DIMD mode.

Besides, the two implicitly derived intra modes are included into the MPM list so that the DIMD process is performed before the MPM list is constructed. The primary derived intra mode of a DIMD block is stored with a block and is used for MPM list construction of the neighbouring blocks.

### DIMD Chroma Mode

The DIMD chroma mode uses the DIMD derivation method to derive the chroma intra prediction mode of the current block based on the neighbouring reconstructed Y, Cb and Cr samples in the second neighbouring row and column as shown in FIG. 11. In FIG. 11, areas 1110, 1120 and 1130 correspond to collocated Y block, current Cb block and current Cr block. The circles outside areas 1110, 1120 and 1130 correspond to respective neighbouring reconstructed samples. The grey circles represent the sample locations where the gradients are determined for DIMD. Specifically, a horizontal gradient and a vertical gradient are calculated for each collocated reconstructed luma sample of the current chroma block, as well as the reconstructed Cb and Cr samples, to build a HoG. Then the intra prediction mode with the largest histogram amplitude values is used for performing chroma intra prediction of the current chroma block.

When the intra prediction mode derived from the DIMD chroma mode is the same as the intra prediction mode derived from the DM mode, the intra prediction mode with the second largest histogram amplitude value is used as the DIMD chroma mode. A CU level flag is signalled to indicate whether the proposed DIMD chroma mode is applied. The best N derived DIMD modes in terms of the histogram amplitudes are then blended to form a final predictor for the current block.

### Fusion of Chroma Intra Prediction Modes

The DM mode and the four default modes can be fused with the MMLM_LT mode as follows:

$$pred = ( w 0 \times pred 0 + w 1 \times pred 1 + ( 1 ≪ ( shift - 1 ) ) ) ≫ shift ,$$

where pred0 is the predictor obtained by applying the non-LM mode, pred1 is the predictor obtained by applying the MMLM_LT mode and pred is the final predictor of the current chroma block. The two weights, w0 and w1 are determined by the intra prediction mode of adjacent chroma blocks and shift is set equal to 2. Specifically, when the above and left adjacent blocks are both coded with LM modes, {w0, w1}={1, 3}; when the above and left adjacent blocks are both coded with non-LM modes, {w0, w1}={3, 1}; otherwise, {w0, w1}={2, 2}.

For the syntax design, if a non-LM mode is selected, one flag is signalled to indicate whether the fusion is applied. This method only applies to I slices.

### Template-Based Intra Mode Derivation (TIMD)

Template-based intra mode derivation (TIMD) mode implicitly derives the intra prediction mode of a CU using a neighbouring template at both the encoder and decoder, instead of signalling the intra prediction mode to the decoder. As shown in FIG. 12, the prediction samples of the template (1212 and 1214) for the current block 1210 are generated using the reference samples (1120 and 1222) of the template for each candidate mode. A cost is calculated as the SATD (Sum of Absolute Transformed Differences) between the prediction samples and the reconstruction samples of the template. The intra prediction mode with the minimum cost is selected as the DIMD mode and used for intra prediction of the CU. The candidate modes may be 67 intra prediction modes as in VVC or extended to 131 intra prediction modes. In general, MPMs can provide a clue to indicate the directional information of a CU. Thus, to reduce the intra mode search space and utilize the characteristics of a CU, the intra prediction mode can be implicitly derived from the MPM list.

For each intra prediction mode in MPMs, the SATD between the prediction and reconstruction samples of the template is calculated. First two intra prediction modes with the minimum SATD are selected as the TIMD modes. These two TIMD modes are fused with weights after applying PDPC process, and such weighted intra prediction is used to code the current CU. Position dependent intra prediction combination (PDPC) is included in the derivation of the TIMD modes.

The costs of the two selected modes are compared with a threshold, in the test, the cost factor of 2 is applied as follows:

$$costMode 2 < 2 * costMode 1.$$

If this condition is true, the fusion is applied, otherwise only model is used (i.e., single mode case). Weights of the modes are computed from their SATD costs as follows:

$$weight 1 = cosMode 2 / ( costMode 1 + costMode 2 )$$

$$weight 2 = 1 - weight 1.$$

### Intra Sub-Partitions (ISP)

The intra sub-partitions (ISP) divides luma intra-predicted blocks vertically or horizontally into 2 or 4 sub-partitions depending on the block size. For example, the minimum block size for ISP is 4×8 (or 8×4). If block size is greater than 4×8 (or 8×4), then the corresponding block is divided by 4 sub-partitions. It has been noted that the M×128 (with M≤64) and 128×N (with N≤64) ISP blocks could generate a potential issue with the 64×64 VDPU (Virtual Decoder Pipeline Unit). For example, an M×128 CU in the single tree case has an M×128 luma TB and two corresponding M/2×64 chroma TBs. If the CU uses ISP, then the luma TB will be divided into four M×32 TBs (only the horizontal split is possible), each of them smaller than a 64×64 block. However, in the current design of ISP chroma blocks are not divided. Therefore, both chroma components will have a size greater than a 32×32 block. Analogously, a similar situation could be created with a 128×N CU using ISP. Hence, these two cases are an issue for the 64×64 decoder pipeline. For this reason, the CU size that can use ISP is restricted to a maximum of 64×64. FIG. 13A and FIG. 13B shows examples of the two possibilities. All sub-partitions fulfil the condition of having at least 16 samples.

In ISP, the dependence of 1×N and 2×N subblock prediction on the reconstructed values of previously decoded 1×N and 2×N subblocks of the coding block is not allowed so that the minimum width of prediction for subblocks becomes four samples. For example, an 8×N (N>4) coding block that is coded using ISP with vertical split is partitioned into two prediction regions each of size 4×N and four transforms of size 2×N. Also, a 4×N coding block that is coded using ISP with vertical split is predicted using the full 4×N block; four transform each of 1×N is used. Although the transform sizes of 1×N and 2×N are allowed, it is asserted that the transform of these blocks in 4×N regions can be performed in parallel. For example, when a 4×N prediction region contains four 1×N transforms, there is no transform in the horizontal direction; the transform in the vertical direction can be performed as a single 4×N transform in the vertical direction. Similarly, when a 4×N prediction region contains two 2×N transform blocks, the transform operation of the two 2×N blocks in each direction (horizontal and vertical) can be conducted in parallel. Thus, there is no delay added in processing these smaller blocks compared to processing 4×4 regular-coded intra blocks.

TABLE 3

| Block Size | Coefficient group Size |
|---|---|
| 1 × N, N ≥ 16 | 1 × 16 |
| N × 1, N ≥ 16 | 16 × 1 |
| 2 × N, N ≥ 8 | 2 × 8 |
| N × 2, N ≥ 8 | 8 × 2 |
| All other possible M × N cases | 4 × 4 |

For each sub-partition, reconstructed samples are obtained by adding the residual signal to the prediction signal. Here, a residual signal is generated by the processes such as entropy decoding, inverse quantization and inverse transform. Therefore, the reconstructed sample values of each sub-partition are available to generate the prediction of the next sub-partition, and each sub-partition is processed consecutively. In addition, the first sub-partition to be processed is the one containing the top-left sample of the CU and then continuing downwards (horizontal split) or rightwards (vertical split). As a result, reference samples used to generate the sub-partitions prediction signals are only located at the left and above sides of the lines. All sub-partitions share the same intra mode.

### Template Matching Prediction (TMP)

Template matching prediction (TMP) is a special intra prediction mode that copies the best prediction block from the reconstructed part of the current frame, whose L-shaped template matches the current template. This is illustrated in FIG. 14, where block 1420 corresponds to a current block in a current picture 1410, and block 1430 corresponds to a reference block. Area 1422 corresponds to template of the current block 1420 and area 1432 corresponds to template of the reference block 1430. For a predefined search range 1440, the encoder searches for the most similar template to the current template in the reconstructed part of the current frame, and uses the corresponding block as a prediction block (as a reference block). The encoder then signals the usage of this mode, and the inverse operation is made at the decoder side.

### CCLM (Cross Component Linear Model)

The main idea behind CCLM mode (sometimes abbreviated as LM mode) is as follows: chroma components of a block can be predicted from the collocated reconstructed luma samples by linear models whose parameters are derived from already reconstructed luma and chroma samples that are adjacent to the block.

In VVC, the CCLM mode makes use of inter-channel dependencies by predicting the chroma samples from reconstructed luma samples. This prediction is carried out using a linear model in the form

$$P ( i , j ) = a \cdot {rec}_{L}^{′} ( i , j ) + b . \qquad ( 3 )$$

Here, P(i, j) represents the predicted chroma samples in a CU and

$${rec}_{L}^{′} ( i , j )$$

represents the reconstructed luma samples of the same CU which are down-sampled for the case of non-4:4:4 colour format. The model parameters a and b are derived based on reconstructed neighbouring luma and chroma samples at both encoder and decoder side without explicit signalling.

Three CCLM modes, i.e., CCLM_LT, CCLM_L, and CCLM_T, are specified in VVC. These three modes differ with respect to the locations of the reference samples that are used for model parameter derivation. Samples only from the top boundary are involved in the CCLM_T mode and samples only from the left boundary are involved in the CCLM_L mode. In the CCLM_LT mode, samples from both the top boundary and the left boundary are used.

Overall, the prediction process of CCLM modes consists of three steps:
1) Down-sampling of the luma block and its neighbouring reconstructed samples to match the size of corresponding chroma block,
2) Model parameter derivation based on reconstructed neighbouring samples, and
3) Applying the model equation (1) to generate the chroma intra prediction samples.

Down-sampling of the Luma Component: To match the chroma sample locations for 4:2:0 or 4:2:2: colour format video sequences, two types of down-sampling filter can be applied to luma samples, both of which have a 2-to-1 down-sampling ratio in the horizontal and vertical directions. These two filters correspond to “type-0” and “type-2” 4:2:0 chroma format content, respectively and are given by

$${f}_{1} = ( \begin{matrix}0 & 1 & 0 \\ 1 & 4 & 1 \\ 0 & 1 & 0\end{matrix} ) , {f}_{2} = ( \begin{matrix}1 & 2 & 1 \\ 1 & 2 & 1\end{matrix} ) . \qquad ( 4 )$$

Based on the SPS-level flag information, the 2-dimensional 6-tap (i.e., f₂) or 5-tap (i.e., f₁) filter is applied to the luma samples within the current block as well as its neighbouring luma samples. The SPS-level refers to Sequence Parameter Set level. An exception happens if the top line of the current block is a CTU boundary. In this case, the one-dimensional filter [1, 2, 1]/4 is applied to the above neighboring luma samples in order to avoid the usage of more than one luma line above the CTU boundary.

Model Parameter Derivation Process: The model parameters a and b from eqn. (4) are derived based on reconstructed neighbouring luma and chroma samples at both encoder and decoder sides to avoid the need for any signalling overhead. In the initially adopted version of the CCLM mode, the linear minimum mean square error (LMMSE) estimator was used for derivation of the parameters. In the final design, however, only four samples are involved to reduce the computational complexity. FIG. 15 shows the relative sample locations of M×N chroma block 1510, the corresponding 2M×2N luma block 1520 and their neighbouring samples (shown as filled circles and triangles) of “type-0” content.

In the example of FIG. 15, the four samples used in the CCLM_LT mode are shown, which are marked by triangular shape. They are located at the positions of M/4 and M·¾ at the top boundary and at the positions of N/4 and N·¾ at the left boundary. In CCLM_T and CCLM_L modes, the top and left boundary are extended to a size of (M+N) samples, and the four samples used for the model parameter derivation are located at the positions (M+N)/8, (M+N)·⅜, (M+N)·⅝, and (M+N)·⅞.

Once the four samples are selected, four comparison operations are used to determine the two smallest and the two largest luma sample values among them. Let Xₗ denote the average of the two largest luma sample values and let Xₛ denote the average of the two smallest luma sample values. Similarly, let Yₗ and Yₛ denote the averages of the corresponding chroma sample values. Then, the linear model parameters are obtained according to the following equation:

$$a = \frac{{Y}_{l} - {Y}_{s}}{{X}_{l} - {X}_{s}} \qquad ( 5 )$$

$$b = {Y}_{s - a} \cdot {X}_{s} .$$

In this equation, the division operation to calculate the parameter a is implemented with a look-up table. To reduce the memory required for storing this table, the diff value, which is the difference between the maximum and minimum values, and the parameter a are expressed by an exponential notation. Here, the value of diff is approximated with a 4-bit significant part and an exponent. Consequently, the table for 1/diff only consists of 16 elements. This has the benefit of both reducing the complexity of the calculation and decreasing the memory size required for storing the tables.

### MMLM Overview

As indicated by the name, the original CCLM mode employs one linear model for predicting the chroma samples from the luma samples for the whole CU, while in MMLM (Multiple Model CCLM), there can be two models. In MMLM, neighbouring luma samples and neighbouring chroma samples of the current block are classified into two groups, each group is used as a training set to derive a linear model (i.e., particular α and β are derived for a particular group). Furthermore, the samples of the current luma block are also classified based on the same rule for the classification of neighbouring luma samples.
Threshold is calculated as the average value of the neighbouring reconstructed luma samples. A neighbouring sample with Rec′L[x,y]<=Threshold is classified into group 1; while a neighbouring sample with Rec′L[x,y]>Threshold is classified into group 2.
Correspondingly, a prediction for chroma is obtained using linear models:

$$\{ \begin{matrix}P r e {d}_{C} [ x , y ] = {α}_{1} \times {Rec}_{L}^{′} [ x , y ] + {β}_{1} & if {Rec}_{L}^{′} [ x , y ] \leq Threshold \\ P r e {d}_{C} [ x , y ] = {α}_{2} \times {Rec}_{L}^{′} [ x , y ] + {β}_{2} & if {Rec}_{L}^{′} [ x , y ] > Threshold\end{matrix}$$

### Chroma Intra Mode Coding

For chroma intra mode coding, a total of 8 intra modes are allowed for chroma intra mode coding. Those modes include five traditional intra modes and three cross-component linear model modes (CCLM, LM_A, and LM_L). Chroma mode signalling and derivation process are shown in the following. Chroma mode coding directly depends on the intra prediction mode of the corresponding luma block. Since separate block partitioning structure for luma and chroma components is enabled in I slices, one chroma block may correspond to multiple luma blocks. Therefore, for Chroma DM mode, the intra prediction mode of the corresponding luma block covering the centre position of the current chroma block is directly inherited.

TABLE 4
Derivation of chroma prediction mode
from luma mode when CCLM_is enabled

| | Corresponding luma intra prediction mode | | | | |
|---|---|---|---|---|---|
| Chroma prediction mode | 0 | 50 | 18 | 1 | X (0 <= X <= 66) |
| 0 | 66 | 0 | 0 | 0 | 0 |
| 1 | 50 | 66 | 50 | 50 | 50 |
| 2 | 18 | 18 | 66 | 18 | 18 |
| 3 | 1 | 1 | 1 | 66 | 1 |
| 4 | 0 | 50 | 18 | 1 | X |
| 5 | 81 | 81 | 81 | 81 | 81 |
| 6 | 82 | 82 | 82 | 82 | 82 |
| 7 | 83 | 83 | 83 | 83 | 83 |

A single binarization table is used regardless of the value of sps_cclm_enabled_flag as shown in Table 5.

TABLE 5
Unified binarization table for chroma prediction mode

| Value of | |
|---|---|
| intra_chroma_pred_mode | Bin string |
| 4 | 00 |
| 0 | 0100 |
| 1 | 0101 |
| 2 | 0110 |
| 3 | 0111 |
| 5 | 10 |
| 6 | 110 |
| 7 | 111 |

The first bin indicates whether it is regular (0) or LM modes (1). If it is LM mode, then the next bin indicates whether it is LM_CHROMA (0) or not. If it is not LM_CHROMA, next 1 bin indicates whether it is LM_L (0) or LM_A (1). For this case, when sps_cclm_enabled_flag is 0, the first bin of the binarization table for the corresponding intra_chroma_pred_mode can be discarded prior to the entropy coding. Or, in other words, the first bin is inferred to be 0 and hence not coded. This single binarization table is used for both sps_cclm_enabled_flag equal to 0 and 1 cases. The first two bins are context coded with its own context model, and the rest bins are bypass coded.

### Convolutional Cross-Component Model (CCCM)

In CCCM, a convolutional model is applied to improve the chroma prediction performance. The convolutional model has 7-tap filter consisting of a 5-tap plus sign shape spatial component, a nonlinear term and a bias term. The input to the spatial 5-tap component of the filter consists of a centre (C) luma sample which is collocated with the chroma sample to be predicted and its above/north (N), below/south(S), left/west (W) and right/east (E) neighbours as shown in FIG. 16.

The nonlinear term (denoted as P) is represented as power of two of the centre luma sample C and scaled to the sample value range of the content:

$$P = ( C * C + midVal ) >> bitDepth .$$

For example, for 10-bit contents, the nonlinear term is calculated as:

$$P = ( C * C + 512 ) >> 10$$

The bias term (denoted as B) represents a scalar offset between the input and output (similarly to the offset term in CCLM) and is set to the middle chroma value (512 for 10-bit content).

Output of the filter is calculated as a convolution between the filter coefficients cᵢ and the input values and clipped to the range of valid chroma samples:

$$predChromaVal = {c}_{0} C + {c}_{1} N + {c}_{2} S + {c}_{3} E + {c}_{4} W + {c}_{5} P + {c}_{6} B$$

The filter coefficients cᵢ are calculated by minimising MSE between predicted and reconstructed chroma samples in the reference area. FIG. 17 illustrates an example of the reference area which consists of 6 lines of chroma samples above and left of the PU. Reference area extends one PU width to the right and one PU height below the PU boundaries. Area is adjusted to include only available samples. The extensions to the area (indicated as “paddings”) are needed to support the “side samples” of the plus-shaped spatial filter in FIG. 16 and are padded when in unavailable areas.

The MSE minimization is performed by calculating autocorrelation matrix for the luma input and a cross-correlation vector between the luma input and chroma output. Autocorrelation matrix is LDL decomposed and the final filter coefficients are calculated using back-substitution. The process follows roughly the calculation of the ALF filter coefficients in ECM, however LDL decomposition was chosen instead of Cholesky decomposition to avoid using square root operations.

Also, similarly to CCLM, there is an option of using a single model or multi-model variant of CCCM. The multi-model variant uses two models, one model derived for samples above the average luma reference value and another model for the rest of the samples (following the spirit of the CCLM design). Multi-model CCCM mode can be selected for PUs which have at least 128 reference samples available.

### Gradient Linear Model (GLM)

Compared with the CCLM, instead of down-sampled luma values, the GLM utilizes luma sample gradients to derive the linear model. Specifically, when the GLM is applied, the input to the CCLM process, i.e., the down-sampled luma samples L, are replaced by luma sample gradients G. The other parts of the CCLM (e.g., parameter derivation, prediction sample linear transform) are kept unchanged.

$$C = α \cdot G + β$$

For signalling, when the CCLM mode is enabled for the current CU, two flags are signalled separately for Cb and Cr components to indicate whether GLM is enabled for each component. If the GLM is enabled for one component, one syntax element is further signalled to select one of 16 gradient filters (1810-1840 in FIG. 18) for the gradient calculation. The GLM can be combined with the existing CCLM by signalling one extra flag in bitstream. When such combination is applied, the filter coefficients that are used to derive the input luma samples of the linear model are calculated as the combination of the selected gradient filter of the GLM and the down-sampling filter of the CCLM.

### Spatial GPM

JVET-Z0124 (Fan Wang, et al., “Non-EE2: Spatial GPM”, Joint Video Exploration Team (JVET) of ITU-T SG 16 WP 3 and ISO/IEC JTC 1/SC 29/WG 11, 26th Meeting, by teleconference, 20-29 Apr. 2022, Document JVET-Z0124) proposed to extend GPM to intra prediction. Similar to inter GPM, SGPM (Spatial Geometric Partitioning Mode) consists of one partition mode and two associated intra prediction modes as shown in FIG. 19A. If these modes are directly signalled in the bit-stream, as shown in FIG. 19B, it would yield significant overhead bits. To express the necessary partition and prediction information more efficiently in the bit-stream, a candidate list is employed and only the candidate index is signalled in the bit-stream. Each candidate in the list can derive a combination of one partition mode and two intra prediction modes, as shown in FIG. 19C.

A template is used to generate this candidate list. The shape of the template is shown in FIG. 20. For each possible combination of one partition mode and two intra prediction modes, a prediction is generated for the template with the partitioning weight extended to the template, as shown in FIG. 20 These combinations are ranked in ascending order based on their SATD between the prediction and reconstruction of the template. The length of the candidate list is set equal to 16, and these candidates are regarded as the most probable SGPM combinations for the current block. Both encoder and decoder construct the same candidate list based upon the template.

To reduce the complexity in building the candidate list, both the number of possible partition modes and the number of possible intra prediction modes are pruned. In the following test, 26 out of 64 partition modes are used, and only the MPMs out of 67 intra prediction modes are used.

The following show more schemes to speed up the encoding time of SGPM and improve the gain of SGPM. More details regarding SGPM can be found in JVET-AA0118 (Fan Wang, et al., “EE2-1.4: Spatial GPM”, Joint Video Exploration Team (JVET) of ITU-T SG 16 WP 3 and ISO/IEC JTC 1/SC 29/WG 11, 27th Meeting, by teleconference, 13-22 Jul. 2022, Document JVET-AA0118).

### Matrix Weighted Intra Prediction

Matrix weighted intra prediction (MIP) method is a newly added intra prediction technique in VVC. For predicting the samples of a rectangular block of width W and height H, matrix weighted intra prediction (MIP) takes one line of H reconstructed neighbouring boundary samples left of the block and one line of W reconstructed neighbouring boundary samples above the block as input. If the reconstructed samples are unavailable, they are generated as it is done in the conventional intra prediction. The generation of the prediction signal is based on the following three steps, i.e., averaging, matrix vector multiplication and linear interpolation as shown in FIG. 21. One line of H reconstructed neighbouring boundary samples 2112 left of the block and one line of W reconstructed neighbouring boundary samples 2110 above the block are shown as dot-filled small squares. After the averaging process, the boundary samples are down-sampled to top boundary line 2114 and left boundary line 2116. The down-sampled samples are provided to the matric-vector multiplication unit 2120 to generate the down-sampled prediction block 2130. An interpolation process is then applied to generate the prediction block 2140.

### Averaging Neighbouring Samples

Among the boundary samples, four samples or eight samples are selected by averaging based on the block size and shape. Specifically, the input boundaries bdry^{top} and bdry^{left} are reduced to smaller boundaries

$${bdry}_{red}^{top} and {bdry}_{r e d}^{left}$$

by averaging neighbouring boundary samples according to a predefined rule depending on block size. Then, the two reduced boundaries

$${bdry}_{red}^{top} and {bdry}_{r e d}^{left}$$

are concatenated to a reduced boundary vector bdry_{red} which is thus of size four for blocks of shape 4×4 and of size eight for blocks of all other shapes. If mode refers to the MIP-mode, this concatenation is defined as follows:

$${bdry}_{red} = \{ \begin{matrix}[ {bdry}_{red}^{top} , {bdry}_{red}^{left} ] & for W = H = 4 and mode < 18 \\ [ {bdry}_{red}^{left} , {bdry}_{red}^{top} ] & for W = H = 4 and mode \geq 18 \\ [ {bdry}_{red}^{top} , {bdry}_{red}^{left} ] & for max ( W , H ) = 8 and mode < 10 \\ [ {bdry}_{red}^{left} , {bdry}_{red}^{top} ] & for max ( W , H ) = 8 and mode \geq 10 \\ [ {bdry}_{red}^{top} , {bdry}_{red}^{left} ] & for max ( W , H ) > 8 and mode < 6 \\ [ {bdry}_{red}^{left} , {bdry}_{red}^{top} ] & for max ( W , H ) > 8 and mode \geq 6\end{matrix} .$$

### Matrix Multiplication

A matrix vector multiplication, followed by addition of an offset, is carried out with the averaged samples as an input. The result is a reduced prediction signal on a subsampled set of samples in the original block. Out of the reduced input vector bdry_{red}, a reduced prediction signal pred_{red}, which is a signal on the down-sampled block of width W_{red} and height H_{red} is generated. Here, W_{red} and H_{red} are defined as:

$${W}_{red} = \{ \begin{matrix}4 & for max ( W , H ) \leq 8 \\ min ( W , 8 ) & for max ( W , H ) > 8\end{matrix}$$

$${H}_{red} = \{ \begin{matrix}4 & for max ( W , H ) \leq 8 \\ min ( H , 8 ) & for max ( W , H ) > 8\end{matrix}$$

The reduced prediction signal pred_{red} is computed by calculating a matrix vector product and adding an offset:

$${pred}_{red} = A \cdot {bdry}_{red} + b .$$

Here, A is a matrix that has W_{red}·H_{red} rows and 4 columns for W=H=4 and 8 columns for all other cases. b is a vector of size W_{red}·H_{red}. The matrix A and the offset vector b are taken from one of the sets S₀, S₁, S₂. One defines an index idx=idx(W, H) as follows:

$$idx ( W , H ) = \{ \begin{matrix}0 & for W = H = 4 \\ 1 & for max ( W , H ) = 8 \\ 2 & for max ( W , H ) > 8\end{matrix} .$$

Here, each coefficient of the matrix A is represented with 8-bit precision. The set S₀ consists of 16 matrices

$${A}_{0}^{i} , i ∈ \{ 0 , ... , 15 \} ,$$

each of which has 16 rows and 4 columns, and 16 offset vectors

$${b}_{0}^{i} , i ∈ \{ 0 , ... , 16 \} ,$$

each of size 16. Matrices and offset vectors of that set are used for blocks of size 4×4. The set S₁ consists of 8 matrices

$${A}_{1}^{i} , i ∈ \{ 0 , ... , 7 \} ,$$

each of which has 16 rows and 8 columns, and 8 offset vectors

$${b}_{1}^{i} , i ∈ \{ 0 , ... , 7 \} ,$$

each of size 16. The set S₂ consists of 6 matrices

$${A}_{2}^{i} , i ∈ \{ 0 , ... , 5 \} ,$$

each of which has 64 rows and 8 columns, and 6 offset vectors

$${b}_{2}^{i} , i ∈ \{ 0 , ... , 5 \} ,$$

each of size 64.

### Interpolation

The prediction signal at the remaining positions is generated from the prediction signal on the subsampled set by linear interpolation, which is a single-step linear interpolation in each direction. The interpolation is performed firstly in the horizontal direction and then in the vertical direction, regardless of block shape or block size.

Signalling of MIP Mode and Harmonization with Other Coding Tools

For each Coding Unit (CU) in intra mode, a flag indicating whether an MIP mode is to be applied or not is sent. If an MIP mode is to be applied, MIP mode (predModeIntra) is signalled. For an MIP mode, a transposed flag (isTransposed), which determines whether the mode is transposed, and MIP mode Id (modeId), which determines which matrix is to be used for the given MIP mode is derived as follows

$$isTransposed = predModeIntra \& 1$$

$$modeId = predModeIntra ≫ 1$$

MIP coding mode is harmonized with other coding tools by considering following aspects:
LFNST (Low-Frequency Non-Separable Transform) is enabled for MIP on large blocks. Here, the LFNST transforms of planar mode are used
The reference sample derivation for MIP is performed exactly as for the conventional intra prediction modes
For the up-sampling step used in the MIP-prediction, original reference samples are used instead of down-sampled ones
Clipping is performed before up-sampling and not after up-sampling
MIP is allowed up to 64×64 regardless of the maximum transform size
The number of MIP modes is 32 for sizeId=0, 16 for sizeId=1 and 12 for sizeId=2

### Modification of LFNST for MIP Coded Blocks

In JVET-AB0067 (Junyan Huo, et. al., “EE2-4.1: Modification of LFNST for MIP coded block”, Joint Video Experts Team (JVET) of ITU-T SG 16 WP 3 and ISO/IEC JTC 1/SC 29, 28th Meeting, Mainz, DE, 21-28 Oct. 2022, Document: JVET-AB0067), it is proposed to utilize DIMD to derive the LFNST transform set and determine LFNST transpose flag.

In FIG. 22, Matrix-Vector Multiplication 2210 is applied to the input data to generate MIP prediction output 2220. MIP prediction with upsampling 2230 is applied to MIP prediction output 2220 to generate upsampled MIP prediction 2240. The proposed method uses the DIMD 2250 to derive the intra prediction mode of the current block based on the MIP predicted samples before upsampling. Specifically, a horizontal gradient and a vertical gradient are calculated for each predicted sample to build a HoG 2260, as shown in FIG. 22. Then the intra prediction mode with the largest histogram amplitude values is used to determine the LFNST transform set and LFNST Transpose flag.

Furthermore, LFNST is enabled for MIP coded blocks of width and height greater than or equal to 4.

### EE2-4.1: Modification of LFNST for MIP Coded Block

In ECM6.0 (Muhammed Coban, et al., “Algorithm description of Enhanced Compression Model 6 (ECM 6)”, Joint Video Exploration Team (JVET) of ITU-T SG 16 WP 3 and ISO/IEC JTC 1/SC 29/WG 11, 27th Meeting, by teleconference, 13-22 Jul. 2022, Document JVET-AA2025), the LFNST transform set and LFNST transpose flag are both determined by the intra prediction mode predModeIntra of the current transform block. With the predModeIntra, the following operation is conducted:
If the current block is MIP coded block, predModeIntra is mapped to PLANAR;
If the current block is CCLM coded block, predModeIntra is mapped to the co-located luma intra prediction mode;

Then, predModeIntra is further derived from wide angle intra prediction mapping with a range of [−14, 83]. Selection of LFNST transform sets

There are totally 35 transform sets and 3 non-separable transform matrices (kernels) per transform set in LFNST in ECM6.0. The transform set idx lfnstTrSetIdx is defined according to predModeIntra list in Table 6.

TABLE 6
LFNST transform set selection

| Intra pred. mode | −14 | −13 | −12 | −11 | −10 | −9 | −8 | −7 | −6 | −5 | −4 | −3 | −2 | −1 | 0 | 1 |
|---|---|---|---|---|---|---|---|---|---|---|---|---|---|---|---|---|
| LFNST set index | 2 | 2 | 2 | 2 | 2 | 2 | 2 | 2 | 2 | 2 | 2 | 2 | 2 | 2 | 0 | 1 |

| Intra pred. mode | 2 | 3 | 4 | 5 | 6 | 7 | 8 | 9 | 10 | 11 | 12 | 13 | 14 | 15 | 16 | 17 |
|---|---|---|---|---|---|---|---|---|---|---|---|---|---|---|---|---|
| LFNST set index | 2 | 3 | 4 | 5 | 6 | 7 | 8 | 9 | 10 | 11 | 12 | 13 | 14 | 15 | 16 | 17 |
| Intra pred. mode | 18 | 19 | 20 | 21 | 22 | 23 | 24 | 25 | 26 | 27 | 28 | 29 | 30 | 31 | 32 | 33 |
| LFNST set index | 18 | 19 | 20 | 21 | 22 | 23 | 24 | 25 | 26 | 27 | 28 | 29 | 30 | 31 | 32 | 33 |
| Intra pred. mode | 34 | 35 | 36 | 37 | 38 | 39 | 40 | 41 | 42 | 43 | 44 | 45 | 46 | 47 | 48 | 49 |
| LFNST set index | 34 | 33 | 32 | 31 | 30 | 29 | 28 | 27 | 26 | 25 | 24 | 23 | 22 | 21 | 20 | 19 |
| Intra pred. mode | 50 | 51 | 52 | 53 | 54 | 55 | 56 | 57 | 58 | 59 | 60 | 61 | 62 | 63 | 64 | 65 |
| LFNST set index | 18 | 17 | 16 | 15 | 14 | 13 | 12 | 11 | 10 | 9 | 8 | 7 | 6 | 5 | 4 | 3 |

| Intra pred. mode | 66 | 67 | 68 | 69 | 70 | 71 | 72 | 73 | 74 | 75 | 76 | 77 | 78 | 79 | 80 |
|---|---|---|---|---|---|---|---|---|---|---|---|---|---|---|---|
| LFNST set index | 2 | 2 | 2 | 2 | 2 | 2 | 2 | 2 | 2 | 2 | 2 | 2 | 2 | 2 | 2 |

### Determination of LFNST Transpose Flag

The LFNST transpose flag determines the scan order of the LFNST output (Decoder). FIG. 23AB shows the scan order with different LFNST transpose flag (FIG. 23A for flag equal to 0 and FIG. 23B for flag equal to 1).

The LFNST transpose flag is determined by predModeIntra as follows:
if predModeIntra is less than or equal to 34, the LFNST transpose flag is set to 0;
else, the LFNST transpose flag is set to 1.

For MIP coded blocks, it is mapped to the PLANAR mode, the LFNST transform set 0 is used and LFNST transpose flag is always equal to 0.

In ECM6.0, LFNST is enable for the MIP coded blocks with the width and height greater than or equal to 16.

### Prediction Process of MIP

As mentioned earlier, Matrix weighted intra prediction (MIP) takes one line of H reconstructed neighbouring boundary samples on the left of the block and one line of W reconstructed neighbouring boundary samples above the block as input. The generation of the prediction samples is based on the following three steps: the input 2410 comprising boundary samples (shown as darker squares) around a current block is provided to boundary downsampling module 2420; and then processed by matrix vector multiplication module 2430 to generate MIP prediction 2440; and further processed by MIP prediction upsampling module 2450 to generate the upsampled output 2460 as shown in FIG. 24.

Specifically, MIP first downsamples the reference samples, and then multiplies the downsampled reference samples with the prediction matrix to generate partial prediction samples. Finally, it is upsampled to generate predicted samples at the remaining positions.

### Chroma DM Mode

For Chroma DM mode, the intra prediction mode of the corresponding (collocated) luma block covering the centre position of the current chroma block is directly inherited.

### Intra Block Copy

Intra block copy (IBC) is a tool adopted in HEVC extensions on SCC (Screen Content Coding). It is well known that it significantly improves the coding efficiency of screen content materials. Since IBC mode is implemented as a block level coding mode, block matching (BM) is performed at the encoder to find the optimal block vector (or motion vector) for each CU. Here, a block vector is used to indicate the displacement from the current block to a reference block, which is already reconstructed inside the current picture. The luma block vector of an IBC-coded CU is in integer precision. The chroma block vector is rounded to integer precision as well. When combined with AMVR (Adaptive Motion Vector Resolution), the IBC mode can switch between 1-pel and 4-pel motion vector precisions. An IBC-coded CU is treated as the third prediction mode other than intra or inter prediction modes. The IBC mode is applicable to the CUS with both width and height smaller than or equal to 64 luma samples.

At the encoder side, hash-based motion estimation is performed for IBC. The encoder performs RD check for blocks with either width or height no larger than 16 luma samples. For non-merge mode, the block vector search is performed using hash-based search first. If hash search does not return a valid candidate, block matching based local search will be performed.

In the hash-based search, hash key matching (32-bit CRC) between the current block and a reference block is extended to all allowed block sizes. The hash key calculation for every position in the current picture is based on 4×4 subblocks. For the current block of a larger size, a hash key is determined to match that of the reference block when all the hash keys of all 4×4 subblocks match the hash keys in the corresponding reference locations. If hash keys of multiple reference blocks are found to match that of the current block, the block vector costs of each matched reference are calculated and the one with the minimum cost is selected.

In block matching search, the search range is set to cover both the previous and current CTUs.

At CU level, IBC mode is signalled with a flag and it can be signalled as IBC AMVP (Advanced Motion Vector Prediction) mode or IBC skip/merge mode as follows:
IBC skip/merge mode: a merge candidate index is used to indicate which of the block vectors in the list from neighbouring candidate IBC coded blocks is used to predict the current block. The merge list consists of spatial, HMVP (History based Motion Vector Prediction), and pairwise candidates.
IBC AMVP mode: block vector difference is coded in the same way as a motion vector difference. The block vector prediction method uses two candidates as predictors, one from left neighbour and one from above neighbour (if IBC coded). When either neighbour is not available, a default block vector will be used as a predictor. A flag is signalled to indicate the block vector predictor index.

### IBC Reference Region

To reduce memory consumption and decoder complexity, the IBC in VVC allows only the reconstructed portion of the predefined area including the region of current CTU and some region of the left CTU. FIG. 25 illustrates the reference region of IBC Mode, where each block represents 64×64 luma sample unit. Depending on the location of the current coded CU within the current CTU, the following applies:

If the current block falls into the top-left 64×64 block of the current CTU (case 2510 in FIG. 25), then in addition to the already reconstructed samples in the current CTU, it can also refer to the reference samples in the bottom-right 64×64 blocks of the left CTU, using current picture referencing (CPR) mode. (More details of CPR can be found in JVET-T2002 (Jianle Chen, et. al., “Algorithm description for Versatile Video Coding and Test Model 11 (VTM 11)”, Joint Video Experts Team (JVET) of ITU-T SG 16 WP 3 and ISO/IEC JTC 1/SC 29, 20th Meeting, by teleconference, 7-16 Oct. 2020, Document: JVET-T2002)). The current block can also refer to the reference samples in the bottom-left 64×64 block of the left CTU and the reference samples in the top-right 64×64 block of the left CTU, using CPR mode.
If the current block falls into the top-right 64×64 block of the current CTU (case 2520 in FIG. 25), then in addition to the already reconstructed samples in the current CTU, if luma location (0, 64) relative to the current CTU has not yet been reconstructed, the current block can also refer to the reference samples in the bottom-left 64×64 block and bottom-right 64×64 block of the left CTU, using CPR mode; otherwise, the current block can also refer to reference samples in bottom-right 64×64 block of the left CTU.
If the current block falls into the bottom-left 64×64 block of the current CTU (case 2530 in FIG. 25), then in addition to the already reconstructed samples in the current CTU, if luma location (64, 0) relative to the current CTU has not yet been reconstructed, the current block can also refer to the reference samples in the top-right 64×64 block and bottom-right 64×64 block of the left CTU, using CPR mode. Otherwise, the current block can also refer to the reference samples in the bottom-right 64×64 block of the left CTU, using CPR mode.
If current block falls into the bottom-right 64×64 block of the current CTU (case 2540 in FIG. 25), it can only refer to the already reconstructed samples in the current CTU, using CPR mode.

This restriction allows the IBC mode to be implemented using local on-chip memory for hardware implementations.

### Inter Prediction Overview

According to JVET-T2002 Section 3.4. (Jianle Chen, et. al., “Algorithm description for Versatile Video Coding and Test Model 11 (VTM 11)”, Joint Video Experts Team (JVET) of ITU-T SG 16 WP 3 and ISO/IEC JTC 1/SC 29, 20th Meeting, by teleconference, 7-16 Oct. 2020, Document: JVET-T2002)), for each inter-predicted CU, motion parameters consist of motion vectors, reference picture indices and reference picture list usage index, and additional information needed for the new coding feature of VVC to be used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU, which are obtained from neighbouring CUs, including spatial and temporal candidates, and additional schedules introduced in VVC. The merge mode can be applied to any inter-predicted CU, not only for skip mode. The alternative to the merge mode is the explicit transmission of motion parameters, where motion vector, corresponding reference picture index for each reference picture list and reference picture list usage flag and other needed information are signalled explicitly per each CU.

Beyond the inter coding features in HEVC, VVC includes a number of new and refined inter prediction coding tools listed as follows:
Extended merge prediction
Merge mode with MVD (MMVD)
Symmetric MVD (SMVD) signalling
Affine motion compensated prediction
Subblock-based temporal motion vector prediction (SbTMVP)
Adaptive motion vector resolution (AMVR)
Motion field storage: 1/16^{th} luma sample MV storage and 8×8 motion field compression
Bi-prediction with CU-level weight (BCW)
Bi-directional optical flow (BDOF)
Decoder side motion vector refinement (DMVR)
Geometric partitioning mode (GPM)
Combined inter and intra prediction (CIIP)

The following description provides the details of those inter prediction methods specified in VVC.

### Extended Merge Prediction

In VVC, the merge candidate list is constructed by including the following five types of candidates in order:
1) Spatial MVP from spatial neighbour CUs
2) Temporal MVP from collocated CUs
3) History-based MVP from an FIFO table
4) Pairwise average MVP
5) Zero MVs.

The size of merge list is signalled in sequence parameter set (SPS) header and the maximum allowed size of merge list is 6. For each CU coded in the merge mode, an index of best merge candidate is encoded using truncated unary binarization (TU). The first bin of the merge index is coded with context and bypass coding is used for remaining bins.

The derivation process of each category of the merge candidates is provided in this session. As done in HEVC, VVC also supports parallel derivation of the merge candidate lists (or called as merging candidate lists) for all CUs within a certain size of area.

### Spatial Candidate Derivation

The derivation of spatial merge candidates in VVC is the same as that in HEVC except that the positions of first two merge candidates are swapped. A maximum of four merge candidates (B0, A0, B1 and A1) for current CU 2610 are selected among candidates located in the positions depicted in FIG. 26. The order of derivation is B0, A0, B1, A1 and B2. Position B2 is considered only when one or more neighbouring CU of positions B0, A0, B1, A1 are not available (e.g. belonging to another slice or tile) or is intra coded. After candidate at position A1 is added, the addition of the remaining candidates is subject to a redundancy check which ensures that candidates with the same motion information are excluded from the list so that coding efficiency is improved. To reduce computational complexity, not all possible candidate pairs are considered in the mentioned redundancy check. Instead, only the pairs linked with an arrow in FIG. 27 are considered and a candidate is only added to the list if the corresponding candidate used for redundancy check does not have the same motion information.

Merge Mode with MVD (MMVD)

In addition to the merge mode, where the implicitly derived motion information is directly used for prediction samples generation of the current CU, the merge mode with motion vector differences (MMVD) is introduced in VVC. A MMVD flag is signalled right after sending a regular merge flag to specify whether MMVD mode is used for a CU.

In MMVD, after a merge candidate is selected (referred as a base merge candidate in this disclosure), it is further refined by the signalled MVDs information. The further information includes a merge candidate flag, an index to specify motion magnitude, and an index for indication of motion direction. In MMVD mode, one for the first two candidates in the merge list is selected to be used as MV basis. The MMVD candidate flag is signalled to specify which one is used between the first and second merge candidates.

Distance index specifies motion magnitude information and indicates the pre-defined offset from the starting points (2812 and 2822) for a L0 reference block 2810 and L1 reference block 2820. As shown in FIG. 28, an offset is added to either horizontal component or vertical component of the starting MV, where small circles in different styles correspond to different offsets from the centre. The relation of distance index and pre-defined offset is specified in Table 7.

TABLE 7
The relation of distance index and pre-defined offset

| Distance IDX | 0 | 1 | 2 | 3 | 4 | 5 | 6 | 7 |
|---|---|---|---|---|---|---|---|---|
| Offset (in unit of | ¼ | ½ | 1 | 2 | 4 | 8 | 16 | 32 |
| luma sample) | | | | | | | | |

Direction index represents the direction of the MVD relative to the starting point. The direction index can represent the four directions as shown in Table 8. It is noted that the meaning of MVD sign could be variant according to the information of starting MVs. When the starting MVs are an un-prediction MV or bi-prediction MVs with both lists pointing to the same side of the current picture (i.e. POCs of two references both larger than the POC of the current picture, or both smaller than the POC of the current picture), the sign in Table 8 specifies the sign of the MV offset added to the starting MV. When the starting MVs are bi-prediction MVs with the two MVs pointing to the different sides of the current picture (i.e. the POC of one reference larger than the POC of the current picture, and the POC of the other reference smaller than the POC of the current picture), and the difference of POC in list 0 is greater than the one in list 1, the sign in Table 8 specifies the sign of MV offset added to the list0 MV component of the starting MV and the sign for the list1 MV has an opposite value. Otherwise, if the difference of POC in list 1 is greater than list 0, the sign in Table 8 specifies the sign of the MV offset added to the list1 MV component of starting MV and the sign for the list0 MV has an opposite value.

The MVD is scaled according to the difference of POCs in each direction. If the differences of POCs in both lists are the same, no scaling is needed. Otherwise, if the difference of POC in list 0 is larger than the one in list 1, the MVD for list 1 is scaled, by defining the POC difference of L0 as td and POC difference of L1 as tb, described in FIG. 28. If the POC difference of L1 is greater than L0, the MVD for list 0 is scaled in the same way. If the starting MV is uni-predicted, the MVD is added to the available MV.

TABLE 8
Sign of MV offset specified by direction index

| Direction IDX | 00 | 01 | 10 | 11 |
|---|---|---|---|---|
| x-axis | + | − | N/A | N/A |
| y-axis | N/A | N/A | + | − |

### Affine Motion Compensated Prediction

In HEVC, only translation motion model is applied for motion compensation prediction (MCP). While in the real world, there are many kinds of motion, e.g. zoom in/out, rotation, perspective motions and the other irregular motions. In VVC, a block-based affine transform motion compensation prediction is applied. As shown FIGS. 29A-B, the affine motion field of the current block is described by motion information of two control point (4-parameter) in FIG. 29A or three control point motion vectors (6-parameter) in FIG. 29B.

For 4-parameter affine motion model, motion vector at sample location (x, y) in a block is derived as:

$$\{ \begin{matrix}{mv}_{x} = \frac{{mv}_{1 x} - {mv}_{0 x}}{W} x + \frac{{mv}_{1 y} - {mv}_{0 y}}{W} y + {mv}_{0 x} \\ {mv}_{y} = \frac{{mv}_{1 y} - {mv}_{0 y}}{W} x + \frac{{mv}_{1 y} - {mv}_{0 x}}{W} y + {mv}_{0 y}\end{matrix} \qquad ( 6 )$$

For 6-parameter affine motion model, motion vector at sample location (x, y) in a block is derived as:

$$\{ \begin{matrix}{mv}_{x} = \frac{{mv}_{1 x} - {mv}_{0 x}}{W} x + \frac{{mv}_{2 x} - {mv}_{0 x}}{H} y + {mv}_{0 x} \\ {mv}_{y} = \frac{{mv}_{1 y} - {mv}_{0 y}}{W} x + \frac{{mv}_{2 y} - {mv}_{0 y}}{H} y + {mv}_{0 y}\end{matrix} \qquad ( 7 )$$

Where (mv0x, mv0y) is motion vector of the top-left corner control point, (mv1x, mv1y) is motion vector of the top-right corner control point, and (mv2x, mv2y) is motion vector of the bottom-left corner control point.

In order to simplify the motion compensation prediction, block based affine transform prediction is applied. To derive motion vector of each 4×4 luma subblock, the motion vector of the centre sample of each subblock, as shown in FIG. 30, is calculated according to above equations, and rounded to 1/16 fraction accuracy. Then, the motion compensation interpolation filters are applied to generate the prediction of each subblock with the derived motion vector. The subblock size of chroma-components is also set to be 4×4. The MV of a 4×4 chroma subblock is calculated as the average of the MVs of the top-left and bottom-right luma subblocks in the collocated 8×8 luma region.

As is for translational-motion inter prediction, there are also two affine motion inter prediction modes: affine merge mode and affine AMVP mode.

### Affine Merge Prediction

AF_MERGE mode can be applied for CUs with both width and height larger than or equal to 8. In this mode, the CPMVs (Control Point MVs) of the current CU is generated based on the motion information of the spatial neighbouring CUs. There can be up to five CPMVP (CPMV Prediction) candidates and an index is signalled to indicate the one to be used for the current CU. The following three types of CPVM candidate are used to form the affine merge candidate list:
Inherited affine merge candidates that are extrapolated from the CPMVs of the neighbour CUs
Constructed affine merge candidates CPMVPs that are derived using the translational MVs of the neighbour CUs
Zero MVs

In VVC, there are two inherited affine candidates at most, which are derived from the affine motion model of the neighbouring blocks, one from left neighbouring CUs and one from above neighbouring CUs. The candidate blocks are the same as those shown in FIG. 26. For the left predictor, the scan order is A0->A1, and for the above predictor, the scan order is B0->B1->B2. Only the first inherited candidate from each side is selected. No pruning check is performed between two inherited candidates. When a neighbouring affine CU is identified, its control point motion vectors are used to derived the CPMVP candidate in the affine merge list of the current CU. As shown in FIG. 31, if the neighbouring left bottom block A of the current block 3110 is coded in affine mode, the motion vectors v₂, v₃ and v₄ of the top left corner, above right corner and left bottom corner of the CU 3120 containing block A are attained. When block A is coded with 4-parameter affine model, the two CPMVs of the current CU (i.e., v₀ and v₁) are calculated according to v₂, and v₃. In case that block A is coded with 6-parameter affine model, the three CPMVs of the current CU are calculated according to v₂, v₃ and v₄.

Constructed affine candidate means the candidate is constructed by combining the neighbouring translational motion information of each control point. The motion information for the control points is derived from the specified spatial neighbours and temporal neighbour for a current block 3210 as shown in FIG. 32. CPMVk (k=1, 2, 3, 4) represents the k-th control point. For CPMV1, the B2->B3->A2 blocks are checked and the MV of the first available block is used. For CPMV2, the B1->B0 blocks are checked and for CPMV3, the A1->A0 blocks are checked. For TMVP is used as CPMV4 if it's available.

After MVs of four control points are attained, affine merge candidates are constructed based on the motion information. The following combinations of control point MVs are used to construct in order:
{CPMV₁, CPMV₂, CPMV₃}, {CPMV₁, CPMV₂, CPMV₄}, {CPMV₁, CPMV₃, CPMV₄}, {CPMV₂, CPMV₃, CPMV₄}, {CPMV₁, CPMV₂}, {CPMV₁, CPMV₃}

The combination of 3 CPMVs constructs a 6-parameter affine merge candidate and the combination of 2 CPMVs constructs a 4-parameter affine merge candidate. To avoid motion scaling process, if the reference indices of control points are different, the related combination of control point MVs is discarded.

After inherited affine merge candidates and constructed affine merge candidate are checked, if the list is still not full, zero MVs are inserted to the end of the list.

### Affine AMVP Prediction

Affine AMVP mode can be applied for CUs with both width and height larger than or equal to 16. An affine flag in the CU level is signalled in the bitstream to indicate whether affine AMVP mode is used and then another flag is signalled to indicate whether 4-parameter affine or 6-parameter affine is used. In this mode, the difference of the CPMVs of current CU and their predictors CPMVPs is signalled in the bitstream. The affine AVMP candidate list size is 2 and it is generated by using the following four types of CPVM candidate in order:
Inherited affine AMVP candidates that extrapolated from the CPMVs of the neighbour CUs
Constructed affine AMVP candidates CPMVPs that are derived using the translational MVs of the neighbour CUs
Translational MVs from neighbouring CUs
Zero MVs

The checking order of inherited affine AMVP candidates is the same as the checking order of inherited affine merge candidates. The only difference is that, for AVMP candidate, only the affine CU that has the same reference picture as current block is considered. No pruning process is applied when inserting an inherited affine motion predictor into the candidate list.

Constructed AMVP candidate is derived from the specified spatial neighbours shown in FIG. 32. The same checking order is used as that in the affine merge candidate construction. In addition, the reference picture index of the neighbouring block is also checked. In the checking order, the first block that is inter coded and has the same reference picture as in current CUs is used. When the current CU is coded with the 4-parameter affine mode, and mv₀ and mv₁ are both available, they are added as one candidate in the affine AMVP list. When the current CU is coded with 6-parameter affine mode, and all three CPMVs are available, they are added as one candidate in the affine AMVP list. Otherwise, the constructed AMVP candidate is set as unavailable.

If the number of affine AMVP list candidates is still less than 2 after valid inherited affine AMVP candidates and constructed AMVP candidate are inserted, mv₀, mv₁ and mv₂ will be added as the translational MVs in order to predict all control point MVs of the current CU, when available. Finally, zero MVs are used to fill the affine AMVP list if it is still not full.

### Geometric Partitioning Mode (GPM)

In VVC, a geometric partitioning mode is supported for inter prediction. The geometric partitioning mode is signalled using a CU-level flag as one kind of merge mode, with other merge modes including the regular merge mode, the MMVD mode, the CIIP mode and the subblock merge mode. In total 64 partitions are supported by geometric partitioning mode for each possible CU size w×h=2^{m}×2ⁿ with m, n∈{3 . . . 6} excluding 8×64 and 64×8.

When this mode is used, a CU is split into two parts by a geometrically located straight line (shown in FIG. 33). The location of the splitting line is mathematically derived from the angle and offset parameters of a specific partition. Each part of a geometric partition in the CU is inter-predicted using its own motion; only uni-prediction is allowed for each partition, that is, each part has one motion vector and one reference index. The uni-prediction motion constraint is applied to ensure that same as the conventional bi-prediction, only two motion compensated prediction are needed for each CU. The uni-prediction motion for each partition is derived

If geometric partitioning mode is used for the current CU, then a geometric partition index indicating the partition mode of the geometric partition (angle and offset), and two merge indices (one for each partition) are further signalled. The number of maximum GPM candidate size is signalled explicitly in SPS and specifies syntax binarization for GPM merge indices. After predicting each of part of the geometric partition, the sample values along the geometric partition edge are adjusted using a blending processing with adaptive weights. This is the prediction signal for the whole CU, and transform and quantization process will be applied to the whole CU as in other prediction modes. Finally, the motion field of a CU predicted using the geometric partition modes is stored.

### Uni-Prediction Candidate List Construction

The uni-prediction candidate list is derived directly from the merge candidate list constructed according to the extended merge prediction process. Denote n as the index of the uni-prediction motion in the geometric uni-prediction candidate list. The LX motion vector of the n-th extended merge candidate (X=0 or 1, i.e., LX=L0 or L1), with X equal to the parity of n, is used as the n-th uni-prediction motion vector for geometric partitioning mode. These motion vectors are marked with “x” in FIG. 34. In case a corresponding LX motion vector of the n-the extended merge candidate does not exist, the L(1−X) motion vector of the same candidate is used instead as the uni-prediction motion vector for geometric partitioning mode.

### Blending Along the Geometric Partitioning Edge

After predicting each part of a geometric partition using its own motion, blending is applied to the two prediction signals to derive samples around geometric partition edge. The blending weight for each position of the CU are derived based on the distance between individual position and the partition edge as shown in FIG. 35.

### Combined Inter and Intra Prediction (CIIP)

In VVC, when a CU is coded in merge mode, if the CU contains at least 64 luma samples (that is, CU width times CU height is equal to or larger than 64), and if both CU width and CU height are less than 128 luma samples, an additional flag is signalled to indicate if the combined inter/intra prediction (CIIP) mode is applied to the current CU. As its name indicates, the CIIP prediction combines an inter prediction signal with an intra prediction signal. The inter prediction signal in the CIIP mode Pᵢₙₜₑᵣ is derived using the same inter prediction process applied to regular merge mode; and the intra prediction signal Pᵢₙₜᵣₐ is derived following the regular intra prediction process with the planar mode. Then, the intra and inter prediction signals are combined using weighted averaging, where the weight value wt is calculated depending on the coding modes of the top and left neighbouring blocks (as shown in FIG. 36) of current CU 3610 as follows:
If the top neighbour is available and intra coded, then set isIntraTop to 1, otherwise set isIntraTop to 0;

If the left neighbour is available and intra coded, then set isIntraLeft to 1, otherwise set isIntraLeft to 0;
If (isIntraLeft+isIntraTop) is equal to 2, then wt is set to 3;
Otherwise, if (isIntraLeft+isIntraTop) is equal to 1, then wt is set to 2;
Otherwise, set wt to 1.

The CIIP prediction is formed as follows:

$${P}_{CIIP} = ( 4 - wt ) * {P}_{inter} + wt * {P}_{intra} + 2 ) ≫ 2 \qquad ( 8 )$$

### GPM Extension

Several variations of GPM mode (JVET-W0097 (Zhipin Deng, et. al., “AEE2-related: Combination of EE2-3.3, EE2-3.4 and EE2-3.5”, Joint Video Experts Team (JVET) of ITU-T SG 16 WP 3 and ISO/IEC JTC 1/SC 29, 23rd Meeting, by teleconference, 7-16 Jul. 2021, Document: JVET-W0097) and JVET-Y0065 (Yoshitaka Kidani, et. al., “EE2-3.1: GPM with inter and intra prediction (JVET-X0166)”, Joint Video Experts Team (JVET) of ITU-T SG 16 WP 3 and ISO/IEC JTC 1/SC 29, 25th Meeting, by teleconference, 12-21 Jan. 2022, Document: JVET-Y0065) have been proposed to improve the coding efficiency of the GPM mode in the VVC. The methods were included in the exploration experiment (EE2) for further evaluations, the main technical aspects of which are described as follows:

EE2-3.3 on GPM with MMVD (GPM-MMVD): 1) additional MVDs are added to the existing GPM merge candidates; 2) the MVDs are signalled in the same manner as the MMVD in the VVC, i.e., one distance index plus one direction index; 3) two flags are signalled to separately control whether the MMVD is applied to each GPM partition or not.

EE2-3.4-3.5 on GPM with template matching (GPM-TM): 1) template matching is extended to the GPM mode by refining the GPM MVs based on the left and above neighbouring samples of the current CU; 2) the template samples are selected dependent on the GPM split direction; 3) one single flag is signalled to jointly control whether the template matching is applied to the MVs of two GPM partitions or not.

JVET-W0097 proposes a combination of EE2-3.3, EE2-3.4 and EE2-3.5 to further improve the coding efficiency of the GPM mode. Specifically, in the proposed combination, the existing designs in EE2-3.3, EE2-3.4 and EE2-3.5 are kept unchanged while the following modifications are further applied for the harmonization of the two coding tools:
1) The GPM-MMVD and GPM-TM are exclusively enabled to one GPM CU. This is done by firstly signalling the GPM-MMVD syntax. When both two GPM-MMVD control flags are equal to false (i.e., the GPM-MMVD are disabled for two GPM partitions), the GPM-TM flag is signalled to indicate whether the template matching is applied to the two GPM partitions. Otherwise (at least one GPM-MMVD flag is equal to true), the value of the GPM-TM flag is inferred to be false.
2) The GPM merge candidate list generation methods in EE2-3.3 and EE2-3.4-3.5 are directly combined in a manner that the MV pruning scheme in EE2-3.4-3.5 (where the MV pruning threshold is adapted based on the current CU size) is applied to replace the default MV pruning scheme applied in EE2-3.3; additionally, as in EE2-3.4-3.5, multiple zero MVs are added until the GPM candidate list is fully filled.

In JVET-Y0065, in GPM with inter and intra prediction (or named GPM intra), the final prediction samples are generated by weighting inter predicted samples and intra predicted samples for each GPM-separated region. The inter predicted samples are derived by the same scheme as the GPM in the current ECM whereas the intra predicted samples are derived by an intra prediction mode (IPM) candidate list and an index signalled from the encoder. The IPM candidate list size is pre-defined as 3. The available IPM candidates are the parallel angular mode against the GPM block boundary (Parallel mode), the perpendicular angular mode against the GPM block boundary (Perpendicular mode), and the Planar mode as shown FIGS. 37A-C, respectively. Furthermore, GPM with intra and intra prediction as shown FIG. 37D is restricted in the proposed method to reduce the signalling overhead for IPMs and avoid an increase in the size of the intra prediction circuit on the hardware decoder. In addition, a direct motion vector and IPM storage on the GPM-blending area is introduced to further improve the coding performance.

In the present invention, methods to improve the transform process are disclosed.

### BRIEF SUMMARY OF THE INVENTION

A method and apparatus for video coding are disclosed. According to this method, input data associated with a current block are received, wherein the input data comprise residual data to be processed at an encoder side or coded transform data associated with the current block to be decoded at a decoder side. Transform process is applied to the input data, wherein the transform process determines a target transform for the current block, and the target transform is selected from a transform candidate set including at least one additional transform candidate with respect to an original transform candidate set or the target transform is determined depending on an intra prediction mode associated with the current block, a reference region, or one or more neighbouring blocks. Transformed output is provided, wherein the transformed output comprises transform coefficients of the current block at the encoder side or recovered residual data at the decoder side.

In one embodiment, the transform process comprises a primary transform at the encoder side or the transform process comprises an inverse primary transform at the decoder side, and wherein the transform process comprises a secondary transform at the encoder side or the transform process comprises an inverse secondary transform at the decoder side. In one embodiment, the target transform corresponds to a separable or non-separable primary transform or secondary transform.

In one embodiment, the current block is coded using IntraTMP (intra Template Matching Prediction) mode, MIP (Matrix weighted Intra Prediction) mode, SGPM (Spatial Geometric Partitioning Mode), DBV (Direct Block Vector), or horizontal/vertical planar mode. In another embodiment, the current block is coded using a cross-component mode. For example, the current block is coded using CCLM, MMLM, CCCM, GLM, any LM variations, and/or fusion of chroma intra prediction modes. In yet another embodiment, the current block is coded using an inter, intra or IBC mode. In one embodiment, the current block corresponds to a luma block or a chroma block.

In one embodiment, a functionality control for enabling said at least one additional transform candidate is signalled or parsed in SPS (Sequence Parameter Set) or PPS (Picture Parameter Set). In one embodiment, an explicit flag is used to indicate whether to support said at least one additional transform candidate for a chroma block. In one embodiment, one or more explicit syntax elements are used to indicate a maximum number of transform candidates for said at least one additional transform candidate.

In one embodiment, the original transform candidate set consists of DCT-II and said at least one additional transform candidate corresponds to one or more MTS (Multi Transform Selection) candidates. In one embodiment, an on/off control is used at a block level to determine whether to use said at least one additional transform candidate for the current block. In one embodiment, the on/off control is indicated at each chroma TU (Transform Unit) or chroma TB (Transform Block). In one embodiment, if the on/off control indicates said one or more MTS candidates being supported for the current block, MTS type for the chroma TU or chroma TB of the current block is inherited from a luma TU or a luma TB of the current block. In one embodiment, if the on/off control indicates said one or more MTS candidates being supported for the current block, MTS type for the chroma TU of the current block is indicated by a signalled or parsed MTS index, or is inferred as a pre-defined MTS type.

In one embodiment, when the current block uses JCCR (Joint Coding of Chroma Residuals) mode, Cr and Cb components of the current block share a same transform selection.

In one embodiment, when one or more conditions are satisfied, said at least one additional transform candidate is enabled. In one embodiment, for a chroma TU or a chroma TB, said one or more conditions comprise chroma block size, one or more chroma transform coefficients, or both. In another embodiment, said one or more conditions are unified for a chroma component and a luma component.

In one embodiment, the target transform is determined depending on the intra prediction mode derived based on a decoder side derivation technique or a template-based derivation technique on the current block, or said one or more neighbouring blocks. In another embodiment, the target transform is determined depending on the intra prediction mode indicated by a block vector or a motion vector. In yet another embodiment, the intra prediction mode is derived based on mode information in the reference region including a corresponding reference block and/or a neighbouring region of the corresponding reference block.

In one embodiment, the target transform is determined depending on the intra prediction mode derived based on a derivation technique, and wherein the derivation technique varies according to block width of the current block, block height of the current block, block area of the current block, or an explicit syntax of the current block.

### BRIEF DESCRIPTION OF THE DRAWINGS

FIG. 1A illustrates an exemplary adaptive Inter/Intra video encoding system incorporating loop processing.

FIG. 1B illustrates a corresponding decoder for the encoder in FIG. 1A.

FIG. 2 illustrates examples of a multi-type tree structure corresponding to vertical binary splitting (SPLIT_BT_VER), horizontal binary splitting (SPLIT_BT_HOR), vertical ternary splitting (SPLIT_TT_VER), and horizontal ternary splitting (SPLIT_TT_HOR).

FIG. 3 illustrates an example of the signalling mechanism of the partition splitting information in quadtree with nested multi-type tree coding tree structure.

FIG. 4 shows an example of a CTU divided into multiple CUs with a quadtree and nested multi-type tree coding block structure, where the bold block edges represent quadtree partitioning and the remaining edges represent multi-type tree partitioning.

FIG. 5 shows some examples of TT split forbidden when either width or height of a luma coding block is larger than 64.

FIG. 6 shows the intra prediction modes as adopted by the VVC video coding standard.

FIG. 7 illustrates the locations of the neighbouring blocks (L, A, BL, AR, AL) used in the derivation of a general MPM list.

FIGS. 8A-B illustrate examples of wide-angle intra prediction a block with width larger than height (FIG. 8A) and a block with height larger than width (FIG. 8B).

FIG. 9A illustrates an example of selected template for a current block, where the template comprises T lines above the current block and T columns to the left of the current block.

FIG. 9B illustrates an example for T=3 and the HoGs (Histogram of Gradient) are calculated for pixels in the middle line and pixels in the middle column.

FIG. 9C illustrates an example of the amplitudes (ampl) for the angular intra prediction modes.

FIG. 10 illustrates an example of the blending process, where two angular intra modes (M1 and M2) are selected according to the indices with two tallest bars of histogram bars.

FIG. 11 illustrates neighbouring reconstructed Y, Cb and Cr samples used to derive the gradient for DIMD.

FIG. 12 illustrates an example of template-based intra mode derivation (TIMD) mode, where TIMD implicitly derives the intra prediction mode of a CU using a neighbouring template at both the encoder and decoder.

FIG. 13A illustrates an example of Intra Sub-Partition (ISP), where a block is partitioned into two subblocks horizontally or vertically.

FIG. 13B illustrates an example of Intra Sub-Partition (ISP), where a block is partitioned into four subblocks horizontally or vertically.

FIG. 14 illustrates an example of template matching based prediction.

FIG. 15 shows the relative sample locations of M×N chroma block, the corresponding 2M×2N luma block and their neighbouring samples (shown as filled circles and triangles) of “type-0” content.

FIG. 16 illustrates an example of spatial part of the convolutional filter.

FIG. 17 illustrates an example of reference area with paddings used to derive the filter coefficients.

FIG. 18 illustrates the 16 gradient patterns for Gradient Linear Model (GLM).

FIGS. 19A-C illustrate an example of spatial GPM and associated signalling.

FIG. 20 illustrates an example of template for Spatial GPM (SGPM).

FIG. 21 illustrates an example of processing flow for Matrix weighted intra prediction (MIP).

FIG. 22 illustrates an example of LFNST modification for MIP coded blocks, which utilizes DIMD to derive the LFNST transform set and determine LFNST transpose flag.

FIGS. 23A-B illustrate the scan orders of the LFNST output with different LFNST transpose flag, where FIG. 23A is for flag equal to 0 and FIG. 23B is for flag equal to 1.

FIG. 24 illustrates an example of processing flow for Matrix weighted intra prediction (MIP).

FIG. 25 illustrates an example of IBC reference region.

FIG. 26 illustrates the neighbouring blocks used for deriving spatial merge candidates for VVC.

FIG. 27 illustrates the possible candidate pairs considered for redundancy check in VVC.

FIG. 28 illustrates the distance offsets from a starting MV in the horizontal and vertical directions according to Merge Mode with MVD (MMVD).

FIG. 29A illustrates an example of the affine motion field of a block described by motion information of two control point (4-parameter).

FIG. 29B illustrates an example of the affine motion field of a block described by motion information of three control point motion vectors (6-parameter).

FIG. 30 illustrates an example of block based affine transform prediction, where the motion vector of each 4×4 luma subblock is derived from the control-point MVs.

FIG. 31 illustrates an example of derivation for inherited affine candidates based on control-point MVs of a neighbouring block.

FIG. 32 illustrates an example of affine candidate construction by combining the translational motion information of each control point from spatial neighbours and temporal.

FIG. 33 illustrates examples of the GPM splits grouped by identical angles.

FIG. 34 illustrates an example of uni-prediction MV selection for the geometric partitioning mode.

FIG. 35 illustrates an example of blending weight ω₀ using the geometric partitioning mode.

FIG. 36 illustrates an example of the weight value derivation for Combined Inter and Intra Prediction (CIIP) according to the coding modes of the top and left neighbouring blocks.

FIGS. 37A-C illustrate examples of available IPM candidates: the parallel angular mode against the GPM block boundary (Parallel mode, FIG. 37A), the perpendicular angular mode against the GPM block boundary (Perpendicular mode, FIG. 37B), and the Planar mode (FIG. 37C), respectively.

FIG. 37D illustrates an example of GPM with intra and intra prediction, where intra prediction is restricted to reduce the signalling overhead for IPMs and hardware decoder cost.

FIG. 38A illustrates an example of applying histogram analysis on the spatially neighbouring reconstructed samples.

FIG. 38B illustrates an example of applying template analysis on the spatially neighbouring reconstructed samples.

FIG. 39A illustrates an example of template including a top template, a left template and a top-left template.

FIG. 39B illustrates an example of template include an extended top template and

an extended left template.

FIG. 40 illustrates an example of DIMD/TIMD on current predictors as the intra prediction mode for transform.

FIG. 41 illustrates an example of DIMD/TIMD on neighbouring reconstruction as the intra prediction mode for transform.

FIG. 42 illustrates a flowchart of an exemplary video coding system that incorporates improved transform process according to an embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

In this invention, a various transform process improvement techniques are disclosed.

In this invention, a novel mechanism of transform process is proposed to improve residual coding for the current block by supporting more transform candidates for a target transform mode. In Section I, a general concept of transform process with our proposed mechanism is introduced. In Section II, the implicit/explicit rules of how to use the additional transform candidates for the current block are introduced. The rules related to functionality control, on/off control, and candidate selection are described in Section II.1 to II.3, respectively. Finally, in Section III, for specific mode-dependent transform selection, the interactions with our proposed mechanism are defined. Note that the proposed methods in Section III are not limited to being used in transform stage and/or can be used in any process/stage mentioned in the Section III. In one embodiment, the current block can be chroma or luma. In another embodiment, the current block can only be chroma. In another embodiment, the current block can only be luma.

### I. General Concept of Transform Process

In a general transform process at the encoder, the residuals for the current block are processed (or transformed) by a primary transform mode and then become the first temporary transform coefficients; the temporary transform coefficients may further be processed by a secondary transform mode and then become the second temporary transform coefficients; and after the remaining operations of residual coding, the bitstream containing the information of transform coefficients is transmitted to decoder. In a general transform process at decoder, the second temporary transformed coefficients are obtained from the received bitstream if the secondary transform is used; the second temporary transformed coefficients may be processed (inverse transformed) by the secondary transform mode and then get the first temporary transformed coefficients if the secondary transform is used; the first temporary transformed coefficients are processed by the first transform mode and then get the residuals for the current block. In the above-mentioned example, up to two transform modes (the primary transform mode and the secondary transform mode) are used for the current block. Note that it is not limited to this case.

In one embodiment, more than two transform modes are used for the current block. That is, at the encoder, after the secondary transform process, more transform modes are applied; at the decoder, before the secondary transform process, more transform modes are applied.

In another embodiment, only one transform mode (e.g. primary transform mode) is used for the current block. For example, when NSPT is used as the primary transform, only the primary transform (no secondary transform) is used for the current block.

In another embodiment, whether to use an additional transform mode for the current block depends on a pre-defined rule. For example, the predefined rule is implicit. For example, the implicit rule refers to block width, block height, block area, and/or neighbouring coding information. For another example, the pre-defined rule is explicit. For example, the explicit rule depends on a block, SPS, PPS, tile, slice, picture, and/or sequence-level flag. In one case, the explicit flag indicates the maximum number of the transform modes for the current block. If the maximum number of the transform modes is 2, the primary transform mode and the secondary transform mode are used for the current block. In another case, the explicit flag indicates whether to use one more transform modes for the current block. For another example, the rule depends on the block properties such as the number of the significant coefficients, the position of the significant coefficients, and/or the distribution of the significant coefficients. The rule can use the syntax related to the position of the last significant coefficient, the syntax related to whether a coding group within the current block contains any significant coefficient, and/or the position of a coding group in the current block.

In another embodiment, the proposed mechanism is to support more transform candidates for a target transform mode. The target transform mode refers to the primary transform mode, secondary transform mode, and/or any of the transform modes (e.g. any of the more than two transform modes).

In another embodiment, if a transform mode refers to a separable transform mode, the transform mode includes a transform type (e.g. matrix or kernel) for horizontal transform and a transform type for vertical transform; otherwise (the transform mode refers to a non-separable transform mode), a joint transform type is used. For example, the primary transform mode is a separable transform mode. For example, the primary transform mode is a non-separable transform mode. For example, the secondary transform mode is a separate (or separable) transform mode. For example, the secondary transform mode is a non-separable transform mode. An example of the separable transform mode is set {horizontal transform, vertical transform} as {DCT-II, DCT-II}, {any transform type of MTS, any transform type of MTS}, {DCT-II, any transform type of MTS}, or {any transform type of MTS, DCT-II}. An example of non-separable transform is LFSNT or NSPT (Non-Separable Primary Transform). For NSPT (a primary transform mode with similar concept to LFNST, but different matrixes from LFNST), 35 transform sets are used for each NSPT type (i.e., NPST4×4, NPST4×8, NPST8×4, and NPST8×8) and the transform set is determined by intra mode. Each NSPT transform set includes three transform kernels and is specified by the explicitly signalled NSPT index. For the example of using DCT-II or MTS as the primary transform and LFNST as the secondary transform (i.e., when MTS is used, secondary transform cannot be used), NSPT is used to replace DCT-II+LFNST for the block sizes 4×4, 4×8, 8×4 and 8×8. Consequently, LFNST4 and LFNST8 will not be tested for these block sizes. However, they are still used for larger block sizes. NSPT here can be extended or modified as
to utilize extra non-separable transforms for 4×4, 4×8, 4×16, 8×4, 8×8, 8×16, 16×4, 16×8 and 16×16 intra blocks
besides the existing DCT-II+LFNST and adaptive MTS, to apply additional non-separable transforms
for each block size, to derive 67 transform kernels based on different intra prediction modes
to signal an additional flag (for example, after the existing MTS flag) to indicate whether the non-separable primary transform is applied. If the flag is true, the syntax of the separable primary transform (for example, MTS index) is not signalled and/or use NSPT instead (for example, the syntax of NSPT being signalled). Otherwise, the syntax of the separable primary transform (for example, MTS index) is further signalled.

In another embodiment, zero-out operations may be used in a transform mode. Whether to parse the signalling of the transform mode at the decoder will check if any significant coefficient is located at the zero-out region. The checking may use the syntax related to the position of the last significant coefficient, the significant flag of a coding group (i.e., whether a coding group contains any significant coefficient), and/or the position of the position of a coding group in the current block. If yes, for example, the checking implying that any significant coefficient is located at the zero-out region, the signalling of the transform mode is bypassed or always indicates disabled (may need bitstream conformance definition); otherwise, the signalling of the transform mode may be signalled and/or parsed at the encoder and/or decoder.

In another embodiment, the current block is coded by intra, inter, or IBC. For example, the prediction type for the current block is MODE_INTRA, MODE_INTER, or MODE_IBC. For the example of the current block coded by intra, at the encoder, the residuals are generated according to prediction based on the spatially neighbouring reference samples and the intra prediction mode; at the decoder, the recovered residuals according to the transform process and the mentioned prediction are used to reconstruct the current block. For the example of the current block coded by inter, at the encoder, the residuals are generated according to prediction based on the reference samples in previous coded pictures and the inter motion information; at the decoder, the recovered residuals according to the transform process and the mentioned prediction are used to reconstruct the current block. For the example of the current block coded by IBC, at the encoder, the residuals are generated according to prediction based on the reference samples in the same picture and the block vector information; at the decoder, the recovered residuals according to the transform process and the mentioned prediction are used to reconstruct the current block.

### II. Signalling/Usage of the Proposed Mechanism

In this section, signalling and usage of additional transform candidate(s) are disclosed. The additional transform candidate(s) mean any additional transform candidate that is allowed in addition to the transform candidate(s) in an original transform candidate set. For example, in a conventional video coding system, only DCT-II is supported for chroma. Therefore, the original transform set for chroma consists of DCT-II only.

### II.1. Signalling of Functionality

In another embodiment, the functionality control of the proposed mechanism depends on the pre-defined rule. For example, the pre-defined rule is implicit according to the sequence resolution, QP, sequence properties (e.g. screen content or not), configurations (e.g. AI/RA/LB), picture type (e.g. LDB), and/or slice type (e.g. inter or intra slice). For example, the pre-defined rule is explicit according to block, CTU, sequence, slice, tile, picture, SPS, PPS-level syntax. For example, an explicit flag indicates whether to support the functionality of the proposed mechanism. For example, an explicit flag indicates the maximum number of the candidates or the maximum number of the candidates for a candidate set of the target transform mode for the current block.

### II.2. On/Off Control

In another embodiment, whether to apply the proposed mechanism to the current block depends on a pre-defined rule. When the pre-defined rule is satisfied, the proposed mechanism is applied to the current block. For the example of the target transform mode in the proposed mechanism being primary transform mode, more candidates (in addition to the default candidate such as DCT-II) for the primary transform mode are supported for the current block.

In another sub-embodiment, when the current block is a chroma block, the transform type of the target transform mode is derived according to one or more collocated luma blocks. The current chroma block can find its collocated luma blocks according to Note A (to be described later) and inherit the suggested transform type used by the pre-defined collocated luma block or most of the collocated luma blocks. The following takes the target transform mode being the primary transform as an example. Note that the proposed methods can be used for any another transform mode. If the pre-defined or most of collocated luma blocks use MTS-type transform candidate as the primary transform mode, the current chroma block will use the MTS-type transform candidate (same as luma or derived from luma) as the primary transform mode.

In one sub-embodiment, the predefined rule is implicit. The implicit rule refers to block width, block height, block area, and/or neighbouring coding information. For the example of the implicit rule being used to decide whether to support the proposed mechanism, if the implicit rule is satisfied, one candidate from the proposed mechanism is applied to the current block; otherwise, the original default candidate/rule (not belonging to additional candidates in the proposed mechanism) is applied to the current block. The following is an example of MTS being the primary transform for the current block. For the larger resolution sequences (width>1080), the maximum CU size for Inter-MTS usage is set to 32 (i.e., Inter-MTS is used for CU with width<=32 and height<=32), and for the remaining sequences (smaller resolution), it is set to 16.

In another sub-embodiment, the pre-defined rule is explicit. For example, the explicit rule depends on a block, SPS, PPS, tile, slice, picture, and/or sequence-level flag. For example, an explicit flag is signalled to indicate whether to support the proposed mechanism (more than one candidates of the target transform mode) for the current block. The explicit signalling depends on the enabling conditions of the proposed mechanism.
If all or any pre-defined subset of the following conditions are satisfied, the explicit signalling is signalled/parsed in the bitstream.
   Condition 1: The block width (or height) is larger than or equal to a predefined threshold (K1), where K1 is 2, 4, 8, 16, 32, 64, or any pre-defined value in the standard.
   Condition 2: The block width (or height) is smaller than a predefined threshold (K2), where K2 is 32, 64, CTB size, maximum transform block size, or any pre-defined value in the standard.
   Condition 3: The block area is larger than or equal to a predefined threshold (K3), where K3 is 2, 4, 8, 16, 32, 64, or any pre-defined value in the standard.
   Condition 4: The block area is smaller than a predefined threshold (K4), where K4 is 16, 64, CTB size*CTB size, maximum transform block size*maximum transform block size, or any pre-defined value in the standard.
   Condition 5: The number of the significant coefficients is larger than a predefined threshold.
   Condition 6: Sum of absolute value of transform coefficients for the current block is in a pre-defined interval [K5, K6] or larger than a predefined threshold.
   Condition 7: The position of the last significant coefficient for the current transform block is larger than a pre-defined threshold K7 where K7=0, 1, 2, a coding group (CG) size.
      K7=0 means that the current transform block contains AC significant coefficients.
      K7=CG size means the current transform block contains significant coefficient in non-first CG.
   Condition 8: The transform skip flag for the current block indicated the transform skip mode disabled.

More conditions can be designed according to the syntax of JCCR, the distribution of the significant coefficients, the syntax related to whether a coding group within the current block contains any significant coefficient, and/or the position of a coding group in the current block. For the example of the current block using JCCR, the chroma residuals are coded jointly (the coded transform block jointly associated cb and cr). The usage (activation) of the JCCR mode is indicated by a TU-level flag tu_joint_cbcr_residual_flag and the selected mode is implicitly indicated by the chroma CBFs. The flag tu_joint_cbcr_residual_flag is present if either or both chroma CBFs for a TU are equal to 1. In another embodiment, the proposed mechanism can be used for one or more colour components. For example, the proposed mechanism is allowed for luma component (Y) only. For another example, the proposed mechanism is allowed for chroma components (including Cb, Cr, or both) only. For another example, the proposed mechanism is allowed for both luma and chroma components. For another example, the usage of the proposed mechanism depends on tree splitting.
In one case:
   If the proposed mechanism is allowed for luma component, the proposed mechanism is allowed for the blocks in luma dual tree and/or the proposed mechanism is allowed for the luma block in single tree; otherwise, the proposed mechanism is disallowed for the blocks in luma dual tree and/or the proposed mechanism is disallowed for the luma block in single tree.
   If the proposed mechanism is allowed for chroma components, the proposed mechanism is allowed for the blocks in chroma dual tree and/or the proposed mechanism is allowed for the chroma block in single tree; otherwise, the proposed mechanism is disallowed for the blocks in chroma dual tree and/or the proposed mechanism is disallowed for the chroma block in single tree.
In another case: In single tree, the proposed mechanism is allowed for only luma components.
In another case: In single tree, the proposed mechanism is allowed for only chroma components.

In another embodiment, the above-mentioned explicit signalling of the proposed mechanism uses context coding bin(s). Some examples are used to select the contexts. For example, luma and each chroma component use separable contexts. That is, Y, Cb, and Cr have their own contexts. For example, each chroma component share the same context(s) (but independent of luma contexts). For example, luma and chroma components share the same context(s).

In one sub-embodiment, the selection of contexts depends on the neighbouring coding information. For the example of the target transform mode being primary transform, if both the above and left neighbouring blocks use non-default transform candidate, one context is used for signalling. Otherwise if only one of the neighbouring blocks uses non-default transform candidate, another context is used for signalling. Otherwise (i.e., none of the left and above neighbouring blocks uses non-default transform candidates), another context is used for signalling.

In another sub-embodiment, the selection of contexts depends on one or more collocated luma blocks. For the example of the target transform mode being primary transform, if the pre-defined collocated luma block uses non-default transform candidate, one context is used for signalling. Otherwise, another context is used for signalling.

In another sub-embodiment, the selection of contexts depends on tree splitting (luma dual tree, chroma dual tree, or single tree), the signalling of the current block such as JCCR, or mode type (intra or inter).

In another embodiment, the signalling or any subset of the enabling conditions for the proposed mechanism are unified between luma and chroma components. For example, one or more thresholds used in a specific enabling condition are the same as luma and chroma.

The proposed mechanism being allowed means the explicit syntax or implicit rule related to the proposed mechanism is required to determine whether to apply the proposed mechanism to the current block or which candidate (supported in the proposed mechanism) is applied to the current block. The proposed mechanism being disallowed means the explicit syntax or implicit rule is not required for the current block and the proposed mechanism is determined to not apply to the current block by inference without syntax or by definition in bitstream conformance.

### II.3. Transform Candidate Selection

In another embodiment, in response to applying the proposed mechanism to the current block, which candidate is used or how the candidate derives depends on a predefined rule. For example, a candidate is indicated to apply to the current block according to the pre-defined rule. For example, the transform matrix for a candidate is derived according to the pre-defined rule.

In one sub-embodiment, if only one candidate is supported, the only one candidate is inferred to be used for the current block. The above condition of “if only one candidate is supported, the only one candidate is inferred to be used for the current block” is referred as Note B in this disclosure.

For example, the transform matrix for the only one candidate is predefined in the standard. For another example of the current block being a chroma block, the transform matrix for the only one candidate is derived according to one or more collocated luma blocks. The collocated luma block(s) can be any one or more from the following definitions, which are referred as Note A in this this disclosure:
Upper-left pixel address of the collocated luma block area refers to the same position of the upper-left pixel address of the current chroma block.
The predefined pixel address of the collocated luma block area has a distance of half of the height of the current coding block in luma samples from above boundary of the collocated luma block area and a distance of half of the width of the current coding block in luma samples from left boundary of the collocated luma block area, where {half of the width and half of height} can refer to {width/2, height/2}, {(width+1)/2, (height+1)/2}, {(width+1)/2, height/2}, and/or {width/2, (height+1)/2}.

In one case: The transform matrix for chroma may be set as the referenced transform matrix from the pre-defined one collocated luma block from the above-mentioned collocated luma blocks. If the referenced transform matrix is not available (e.g. the collocated luma did not use any transform candidate supported in the proposed mechanism for the target transform mode), a pre-defined transform matrix is used instead. The pre-defined method is in the standard or determined by the block width, block height, block area, and/or neighbouring coding information, and/or more in Note C (to be described later).

In another case: An order to check the above-mentioned collocated luma blocks is defined. The transform matrix for chroma is set as the first or the most available referenced transform matrix from the collocated luma blocks. If all of the referenced transform matric are not available (e.g. all collocated luma blocks did not use any transform candidate supported in the proposed mechanism for the target transform mode), a pre-defined transform matrix is used instead. The pre-defined method is in the standard or determined by the block width, block height, block area, neighbouring coding information, and/or more in Note C.
For another example, the transform matrix for the only one candidate is pre-defined in the standard or depends on a pre-defined implicit rule such as block width, block height, block area, and/or neighbouring coding information. Some methods are shown in Note C as follows:
   Note C: Block width, block height, or intra/inter/IBC prediction mode are used to decide a candidate set and the first candidate (with the smallest index) is used.

Take the target transform being primary transform with the proposed mechanism supporting additional MTS-type transform candidates as an example. In the current VVC design, for MTS, only DST7 and DCT8 transform kernels are utilized. Additional MTS-types including DCT5, DST4, DST1, and identity transform (IDT) are employed. MTS set is determined according to the transform block size and intra mode information. Totally, 16 different transform block sizes are considered, and for each transform block size, 5 different classes are considered depending on intra-mode information. Also MTS set is made dependent on the TU size and intra mode information (e.g. representative prediction mode in Section III). For each class, 1, 4 or 6 different transform pairs are considered. Number of intra MTS candidates are adaptively selected (between 1, 4 and 6 MTS candidates) depending on the sum of absolute value of transform coefficients. The sum is compared against the two fixed thresholds to determine the total number of allowed MTS candidates:

$$1 candidate , if sum <= th 0$$

$$4 candidates , if th 0 < sum <= th 1$$

$$6 candidates , if sum > th 1$$

Note, although a total of 80 different classes are considered, some of those different classes often share exactly the same transform set. So there are 58 (less than 80) unique entries in the resultant LUT. For angular modes, a joint symmetry over TU shape and intra prediction is considered. For the wide-angle modes (not ranging in regular intra prediction mode index, for example, not ranging in 0 to 66), the nearest conventional angular mode is used for the transform set determination. For example, mode 2 is used for all the modes between −2 and −14. Similarly, mode 66 is used for mode 67 to mode 80.

For another example of the target transform being primary transform with the proposed mechanism supporting additional MTS-type transform candidates. Four candidates: {(DST7, DST7), (DST7, DCT8), (DCT8, DST7), (DCT8, DCT8)} are used for every CU. For 4-pt, 8-pt and 16-pt transforms, the current transform cores (or kernels), i.e., DST-7 and DCT-8, is replaced with separable KLTs. Luma and chroma components may have unified or different rules.

In another sub-embodiment, the predefined rule is implicit. The implicit rule refers to block width, block height, block area, and/or neighbouring coding information. For the example of the implicit rule being used to decide which of the candidates (supported in the proposed mechanism), the candidate (indicated by the implicit rule) is applied to the current block. For the example of the implicit rule being used to derive the transform matrix for a candidate, the transform matrix used in the candidate is set according to the implicit rule. More methods can be found in Note B.

In another sub-embodiment, the pre-defined rule is explicit. The explicit rule depends on a block, SPS, PPS, tile, slice, picture, and/or sequence-level flag. For example, an explicit index indicates which of the candidates (supported in the proposed mechanism) is used for the current block.

In another embodiment, when the current block is a chroma block, one or more transform candidates for the target transform mode are derived according to one or more collocated luma blocks in Note A. In one sub-embodiment, the transform candidate(s) derived from luma is put as the first candidate in the candidate set. If the transform candidate(s) derived from luma is redundant with any other transform candidates in the set, a pre-defined transform matrix is used to replace the redundant candidate (belonging to the mentioned other transform candidates). The pre-defined method is in the standard or determined by the block width, block height, block area, and/or neighbouring coding information, and/or more in Note C.

In another embodiment, when the proposed mechanism is allowed for chroma components, the signalling (in Sections II.2 and/or II.3) is shared for cb and cr components. That is, one syntax of on/off and/or one syntax of transform candidate selection are signalled and used for both cb and cr components.

In another embodiment, when the proposed mechanism is allowed for chroma components, the signalling (in Sections II.2 and/or II.3) is separate for Cb and Cr components, respectively. That is, one syntax of on/off and/or one syntax of transform candidate selection are signalled and used for Cb, and another syntax of on/off and/or another syntax of transform candidate selection are signalled and used for cr. When JCCR (Joint Coded Residuals/coefficients for Cb and Cr) is used, one syntax of on/off and/or one syntax of transform candidate selection are signalled for the joint coded Cb and Cr.

In another embodiment, the signalling (in Sections II.2 and/or 2.3) of the proposed mechanism is at the transform block level, transform unit level, coding block level, and/or coding unit level.

In another embodiment, when the proposed mechanism is applied to primary transform (as the target transform), secondary transform is inferred (as disabled) according to the on/off signalling of the proposed mechanism.

In another embodiment, when secondary transform is applied to the current block, the proposed mechanism being applied to primary transform is inferred (as disabled) according to the on/off signalling of the secondary transform.

In another embodiment, when the proposed mechanism is applied to secondary transform (as the target transform), primary transform is inferred (as default) according to the on/off signalling of the secondary transform.

In another embodiment, when primary transform (as NSPT) is applied to the current block, the proposed mechanism being applied to secondary transform is inferred (as default to be disabled) according to the on/off signalling of NSPT.

### III. Representative Prediction Mode in Transform

Determining the representative prediction mode for regular intra mode, special intra mode, non-intra mode and/or any mode (in Note D) is proposed.
The regular intra mode means that one or more traditional intra prediction modes and spatially neighbouring reference samples (located in the adjacent or non-adjacent reference line for the current block) are used to generate the predictors for the current block. The regular intra mode may be used for luma and/or chroma components and the used traditional intra prediction modes may be indicated with syntax elements and/or a pre-defined implicit derivation method (such as DIMD which applies histogram analysis to suggest one or more intra prediction modes and/or TIMD which applies template analysis to suggest one or more intra prediction modes).
The special intra mode means that when the current block is coded with the special intra mode, instead of using a traditional intra prediction mode (e.g. one of 67 intra prediction modes) to generate the predictors for the current block, an alternative scheme (such as a matrix-based scheme and/or cross-component information) is applied to the spatially neighbouring reference samples and/or the reference samples from the collocated luma block to generate the predictors for the current block. For example, the special intra mode refers to Matrix-based Intra Prediction (MIP) or any intra mode using a derived or pre-defined matrix and input reference samples to generate prediction of the current block. The special intra mode may be used for luma and/or chroma components. For example, the special intra mode for chroma refers to any one of cross-component modes which mean the current chroma block references predicted/reconstructed samples or any pre-defined information of the one or more collocated luma blocks to generate the prediction for the current chroma block. An example of the cross-component modes are LM modes (such as CCLM and/or MMLM) and/or any one of LM variations (such as CCCM and/or GLM). For example, the special intra mode refers to CCLM, MMLM, CCCM, GLM, any LM variation, or fusion of chroma intra prediction modes. For example, the special intra mode refers to TMP.
The non-intra mode means IBC, inter mode, and/or any mode with mode type not equal to intra mode type (MODE_TYPE_INTRA). The non-intra mode may be used for luma and/or chroma components.

At the prediction stage, to improve prediction efficiency, different modes may apply adjustment when generating predictors or after generating predictors. For the regular intra mode, the final predictors may be the combined predictors based on the multiple hypotheses of predictors from each of the more than one traditional intra prediction modes. Therefore, it is hard to directly find a representative prediction mode among the more than one traditional intra prediction modes. For the special intra mode and/or the non-intra mode and/or any mode (in Note D), the predictors are not generated based on a (traditional) intra prediction mode. However, in some cases, the intra prediction mode for the current block will be required.
In the following encoding/decoding stages after/before/parallel to prediction process, it will use the intra prediction mode for the current block.
   In the transform/inverse transform stage, the intra prediction mode is used by secondary transform, where the transform mode can be any mentioned transform mode in Section I. For example, the case may correspond to selecting the transform set and the transpose flag for secondary transform (e.g. LFNST). The secondary transform in this invention is not limited to LFNST and can be any pre-defined separable/non-separable and/or low-frequency/non-low-frequency transform, which is performed after (or before) primary transform at the encoder (or decoder) and is applied to the primary-transformed (or received-dequantized) coefficients at the encoder (or decoder).
   In the transform/inverse transform stage, the intra prediction mode can be used by primary transform, where the transform mode can be any mentioned transform mode in Section I. For example, the case may correspond to selecting the transform kernel for the primary transform (e.g. a default primary transform such as DCT-II and/or MTS and/or NSPT). The primary transform in this invention can be any pre-defined transform, which is performed on residuals (or inverse-secondary-transformed coefficients or received-dequantized transformed coefficients) at the encoder (or decoder).
   In the transform/inverse transform stage, the intra prediction mode can be used by any transform mode (i.e., may be referred by the primary transform, secondary transform, or any of the more than two transform modes) mentioned in Section I.
For the subsequent coding blocks, the intra prediction mode information from one or more neighbouring or previous coded blocks is used for deriving the MPM list or any scheme which may reference the intra prediction mode information from one or more neighbouring or previous coded blocks.
If the current block is a luma block, the collocated chroma block may need the intra prediction mode from luma (e.g. to decide the chroma DM).

Therefore, when one of the above-mentioned modes is applied to the current block, the proposed novel mechanism can be used to determine a representative prediction mode for using in the one or more above-motioned cases.

In one embodiment, the representative prediction mode is any one of DIMD derived modes (e.g., applying histogram analysis on the spatially neighbouring reconstructed samples adjacent or non-adjacent to the current block), TIMD derived mode (e.g., applying template analysis on the spatially neighbouring reconstructed samples adjacent or non-adjacent to the current block), DC, planar, horizontal, vertical, diagonal, or any pre-defined mode from the available intra prediction modes. Take the current block coded by MIP (which can be changed with any regular intra mode, special intra mode, and/or non-intra mode, and/or any mode (in Note D)) and the pre-defined intra prediction mode being DIMD derived mode as an example. The DIMD derived mode is stored for MIP and/or can be used for any one or more in the following:
the subsequent blocks to derive the MPM list or any scheme which may reference the intra prediction mode information from one or more neighbouring or previous coded blocks
the collocated chroma block to decide its intra prediction mode (e.g. to derive chroma DM) if the current block is luma
the current block to decide the transform kernel for the transform stage

An example of applying histogram analysis on the spatially neighbouring reconstructed samples is shown in FIG. 38A, where region 3820 corresponds to the neighbouring region used as the template for the current block 3820. The window 3822 is applied to each or any subset of the neighbouring region (template). The centre of the window is on each or any subset of the centre samples in the neighbouring region. The centre samples are shown as small circles 3824 filled with dots.

An example of applying template analysis on the spatially neighbouring reconstructed samples is shown in FIG. 38B. TIMD cost (based on the template) is calculated as the distortion between the reconstructed samples and predicted samples in the neighbouring region 3820 (i.e., the template) for the current block 3810, where the predicted samples in the neighbouring region (i.e., the template) are generated according to a candidate prediction mode.

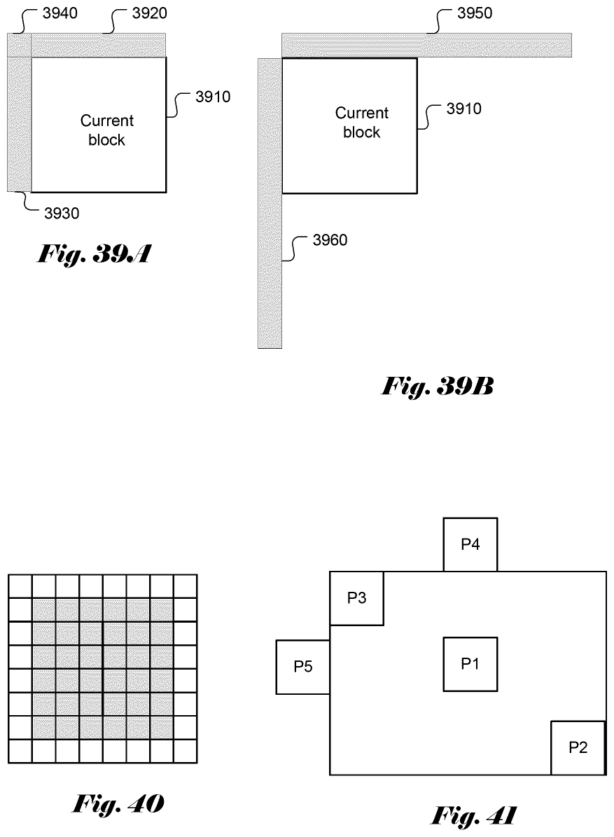

In one sub-embodiment, when using the template in the above examples, the template may include a top template 3920, a left template 3930 and a top-left template 3940 as shown in FIG. 39A for a current block 3910, or any extension from the top template 3950, and/or any extension from the left template 3960, and/or only any subset of the above as shown in FIG. 39B. The size of the top template is pre-defined as block width×H1, the size of the left template is pre-defined as W1×block height, and the size of the top-left template is pre-defined as W1×H1 where W1 and/or H1 are 1, 2, 3, 4, . . . , or any pre-defined values. In one example, H1 and W1 are the same. In another example, H1 and W1 are different. In another example, H1 and/or W1 vary with the block size. If the block height is larger than a pre-defined threshold, H1 gets larger. If the block width is larger than a pre-defined threshold, W1 gets larger. Some extensions of the template are as follows. Width of the extended top template is increased to any pre-defined value larger than block width such as block width+block height or k*block width. Height of the extended left template is increased to any pre-defined value larger than block height such as block height+block width or k*block height.

In another embodiment, the representative prediction mode is determined by applying a pre-defined process to all or any subset of the predicted samples of the current block. The pre-defined process will suggest an intra prediction mode as the representative prediction mode for the current block. In one sub-embodiment, the pre-defined process refers to DIMD and/or TIMD. In one sub-embodiment, when the current block is a chroma block and coded with cross-component mode or fusion of chroma intra prediction mode, the pre-defined process is applied to all or any subset of the reconstructed/predicted samples of the one or more collocated luma blocks. Take DIMD as an example, the window used in DIMD is applied to the predictors within the current block. In another sub-embodiment, the predicted samples for applying the pre-defined process refer to the down-sampled or reduced predicted samples and the pre-defined process is applied to all or any subset of the down-sampled or reduced predicted samples. For example, the original size of the current block is 2M×2N and the reduced or down-sampled size of the current block is M×N by down-sampling from 2M×2N. In another sub-embodiment, as shown in FIG. 40, the centre of window is applied on the samples (in grey area) within the current (or reduced) block but not located at the boundary of the current (or reduced) block. In another sub-embodiment, the centre of window is applied on each sample within the current (or reduced) block. If the window requires any sample outside of the current (or reduced) block, padding from the boundary is used instead of referencing the samples outside of the current (or reduced) block. Take TIMD as an example, the TIMD cost for a candidate prediction mode is calculated as the distortion between the final predicted samples (e.g. if the current block is coded by IBC, the final predictors are generated according to block vectors) and the predicted samples (from a candidate prediction mode) for all or any subset of the current (or reduced) block.

Take the current block coded by MIP (which can be changed with any regular intra mode, special intra mode, and/or non-intra mode, and/or any mode (in Note D)) and the representative prediction mode being from DIMD for the current block as an example. The representative prediction mode is stored for MIP and/or can be used for any one or more in the following
the subsequent blocks to derive the MPM list or any scheme which may reference the intra prediction mode information from one or more neighbouring or previous coded blocks
(If the current block is luma) the collocated chroma block to decide its intra prediction mode (e.g. to derive chroma DM)
the current block to decide the transform kernel for the transform stage

In another embodiment, the representative prediction mode is pre-defined as a default mode. The default mode can be planar, DC, or any pre-defined intra prediction modes in the standard. In one sub-embodiment, the default mode is fixed as one intra prediction mode. In another sub-embodiment, the default mode is selected according to the coding mode of the current block. For example, the default mode of MIP is planar; the default mode of intra TMP is planar; the default mode of SGPM/GPM/any GPM variation is the mode according to partitioning angle or any one mode in the IPM list; the default mode of chroma cross-component mode is chroma DM; the default mode of horizontal/vertical planar is horizontal/vertical; the default mode of DBV is chroma DM or DC or the mode same as the default mode of IBC; the default mode of CIIP is TIMD or planar or any intra prediction mode using in CIIP; and/or the default mode of IBC is DC or planar. For example, the default mode of SGPM is the mode according to partitioning angle; for example, there is a mapping table created to map from the partitioning angle to the default mode and/or the size of the mapping table depends on the number of the candidate partition angles. If the number of the candidate partition angles is 32, the size of the mapping table is 32. The following shows a possible mapping table for the default mode being in one of 67-domain intra prediction modes:
{50, 0, 44, 41, 34, 27, 0, 0, 18, 0, 0, 9, 66, 59, 56, 0, 50, 0, 44, 41, 34, 27, 0, 0, 18, 0, 0, 9, 66, 59, 56, 0}.

The number in { } refers to the default mode. The angle equal to 0 (i.e., vertical partitioning direction) refers to the default mode 50 (i.e., vertical intra prediction mode). The default mode number is symmetric. The first half in the table is the same as the second half in the table. In another example, the angle equal to 0 (i.e., vertical partitioning direction) refers to the default mode 18 (i.e., horizontal intra prediction mode). The mapping table size can be reduced by grouping the N candidate angles into multiple (<N) groups and the group index is used to find a default mode from the mapping table. The size of the mapping table is the number of groups. For example, using angle symmetry (e.g. angle 0 and 16 are symmetry and both are belonging to vertical partition directions), the symmetric angles are put into the same group.

In another embodiment, when the representative prediction mode is any one of DIMD derived mode (applying histogram analysis to the spatially neighbouring reconstructed samples adjacent or non-adjacent to the current block), TIMD derived mode (applying template analysis to the spatially neighbouring reconstructed samples adjacent or non-adjacent to the current block), or any mode that gets the most preferable suggestion (e.g. smallest cost, largest histogram, . . . ) among all candidate modes or when the representative prediction mode is determined by applying a pre-defined process to all or any subset of the predicted samples on the current block, where the pre-defined process (such as DIMD, TIMD, and/or any pre-defined) would suggest an intra prediction mode as the representative prediction mode for the current block, some embodiments are designed to determine whether the suggestion is trustable. If trustable, use the suggested mode as the representative prediction mode for the current block; otherwise, use the default way to decide the representative prediction mode for the current block.

In one sub-embodiment, when using DIMD to suggest the representative prediction mode, whether the suggestion is trustable depends on the distribution of histograms. For example, when the largest histogram is larger than (T*the second largest histogram), the suggestion is trustable, where T is pre-defined as any value, such as 1.25, 1.5, 2.0, larger than 1. In implementation, bit-shifting operation is used instead of multiplying a floating value (T). For example, (2.0*the second largest histogram) is implemented as (the second largest histogram<<1). For another example, (1.25*the second largest histogram) is implemented as (the second largest histogram+the second largest histogram>>2). For another example, (1.5*the second largest histogram) is implemented as (the second largest histogram+the second largest histogram>>1). In another implementation, a lookup table is used instead of multiplying a floating value (T). By using the look table, T is approximated.

In another sub-embodiment, when using TIMD to suggest the representative prediction mode, whether the suggestion is trustable depends on the distribution of TIMD costs. For example, when T2*the smallest cost is smaller than the second smallest histogram, the suggestion is trustable where T2 is pre-defined as any value such as 1.25, 1.5, 2.0 or any value larger than 1. In implementation, bit-shifting operation is used instead of multiplying a floating value (T2). For example, (2.0*the smallest cost) is implemented as (the smallest cost<<1). For another example, (1.25*the smallest cost) is implemented as (the smallest cost+the smallest cost>>2). For another example, (1.5*the smallest cost) is implemented as (the smallest cost+the smallest cost>>1). In another implementation, a lookup table is used instead of multiplying a floating value (T2). By using the look table, T2 is approximated.

In another embodiment, when the representative prediction mode is any one of DIMD derived mode (i.e., applying histogram analysis on the spatially neighbouring reconstructed samples adjacent or non-adjacent to the current block), TIMD derived mode (i.e., applying template analysis on the spatially neighbouring reconstructed samples adjacent or non-adjacent to the current block), or any mode which gets the most preferable suggestion (e.g. smallest cost, largest histogram, . . . ) among all candidate modes or when the representative prediction mode is determined by applying a pre-defined process to all or any subset of the predicted samples to the current block, where the pre-defined process (e.g. DIMD, TIMD, and/or any pre-defined) would suggest an intra prediction mode as the representative prediction mode for the current block, some embodiments are designed to generate a new transform matrix/set according to more than one (e.g. 2) existing transform matrixes/sets selected from more than one (e.g. 2) suggested representative mode and/or the new transform matrix/set is used for the current block. When using DIMD to suggest the representative intra prediction mode and histograms of candidate modes are not easy to be distinguished (e.g. the largest histogram is similar to the second largest histogram), more than one representative modes (e.g. 2) are introduced. When using TIMD to suggest the representative intra prediction mode and costs of candidate modes are not easy to be distinguished (e.g. the smallest cost is similar to the second smallest cost), more than one representative modes (e.g. 2) are introduced.

In one sub-embodiment, the new transform matrix/set is generated by mixing more than one existing transform matrixes/sets. An example of using two existing transform matrixes/sets to mix as the new transform matrix is shown in the following. First one existing transform matrix/set is selected according to one suggested mode and the other existing transform matrix/set is selected according to the other suggested mode. Then, a new matrix/set is generated by mixing all or any subset of the values of transform matrix coefficients in the two existing transform matrixes as the new transform matrix by weighted averaging or mixing all or any subset of the transform matrix members in the two existing transform sets into the new transform set. The weighing for averaging or the rule of selecting members may or may not depend on histograms/costs in the pre-defined process.

In another embodiment, one or more intra prediction modes are pre-defined as preferable modes. when the representative prediction mode is any one of DIMD derived mode (applying histogram analysis on the spatially neighbouring reconstructed samples adjacent or non-adjacent to the current block), TIMD derived mode (i.e., applying template analysis on the spatially neighbouring reconstructed samples adjacent or non-adjacent to the current block), or any mode which got the most preferable suggestion (e.g. smallest cost, largest histogram, . . . ) among all candidate modes or when the representative prediction mode is determined by applying a pre-defined process to all or any subset of the predicted samples on the current block where the pre-defined process (e.g. DIMD, TIMD, and/or any pre-defined) would suggest an intra prediction mode as the representative prediction mode for the current block, some embodiments are designed to give the preferable modes higher priorities and then compared with other non-preferable modes during the pre-defined process. For example, when using DIMD to suggest the representative prediction mode, the histogram of a preferable mode is adjusted by multiplying its histogram by T3, where T3=1.25, 1.5, 2.0, or any value larger than 1. In implementation, bit-shifting operation is used instead of multiplying a floating value (T3). For example, (2.0*the histogram) is implemented as (the histogram<<1). For another example, (1.25*the histogram) is implemented as (the histogram+the histogram>>2). For another example, (1.5*the histogram) is implemented as (the histogram+the histogram>>1). In another implementation, a lookup table is used instead of multiplying a floating value (T3). By using the look table, T3 is approximated. For another example, when using TIMD to suggest the representative prediction mode, the cost of a preferable mode is adjusted by multiplying its cost by T4, where T4=0.25, 0.5, or any value smaller than 1. In implementation, bit-shifting operation is used, instead of multiplying a floating value (T4) or dividing 1/T4. For example, (0.25*the cost) is implemented as (the cost>>2). For another example, (0.5*the cost) is implemented as (the cost>>1). In another implementation, a lookup table is used, instead of multiplying a floating value (T4) or dividing 1/T4. By using the look table, T4 is approximated.

In one sub-embodiment, different coding modes may have different preferable modes. For example, when the current block is coded with SGPM coding mode, the preferable modes are defined according to the partitioning angle for the current block. For another example, when the current block is coded with MIP coding mode, the preferable modes are defined as planar, DC, or any pre-defined intra prediction modes. For another example, when the current block is coded with IBC or inter coding mode, the preferable modes are defined as planar, DC, any intra prediction mode based on mode information for any pre-defined subset of the prediction units (or coding block or any-pre-defined region) in the reference region (including the corresponding reference block indicated by the block vector or the motion vector and/or the neighbouring template of the corresponding reference block), or any pre-defined intra prediction modes. For another example, when the current block is coded with the cross-component mode, the preferable modes are defined as chroma DM, planar, DC, or any pre-defined intra prediction modes. For another example, when the current block is coded with DBV coding mode, the preferable modes are defined as chroma DM, planar, DC, horizontal, vertical, any intra prediction mode based on mode information for any pre-defined subset of the prediction units (or coding block or any-pre-defined region) in the reference region (including the corresponding reference block indicated by the block vector and/or the neighbouring template of the corresponding reference block), or any pre-defined intra prediction modes. For another example, when the current block is coded with the coding mode horizontal planar mode, the preferable modes are defined as planar, DC, horizontal, vertical, or any pre-defined intra prediction modes. For another example, when the current block is coded with the coding mode vertical planar mode, the preferable modes are defined as planar, DC, horizontal, vertical, or any pre-defined intra prediction modes. For another example, when the current block is coded with the intra TMP coding mode, the preferable modes are defined as planar, DC, horizontal, vertical, any intra prediction mode based on mode information for any pre-defined subset of the prediction units (or coding block or any-pre-defined region) in the reference region (including the corresponding reference block indicated by the block vector and/or the neighbouring template of the corresponding reference block), or any pre-defined intra prediction modes. For another example, the preferable modes refer to the default modes.

In another sub-embodiment, when using DIMD to suggest the representative prediction mode, the preferable modes are the first N modes suggested by TIMD, where N=1, 2, . . . , or any positive integer.

In another sub-embodiment, when using TIMD to suggest the representative prediction mode, the preferable modes are the first N2 modes suggested by DIMD, where N2=1, 2, . . . , or any positive integer.

In an alternative way, using mode information of the reference region to derive a representative prediction mode for regular intra mode, special intra mode, and/or non-intra mode, and/or any mode (in Note D) is proposed. Compared to performing texture analysis (DIMD or TIMD) on the predictors within the current block or the spatially neighbouring samples, the alternative proposed method is simpler and/or can output the derived representative intra prediction mode earlier without waiting for the reconstruction or prediction stage to know the required predicted or reconstructed samples. Some embodiments in the following focus on using IBC for the current block. Note that the proposed methods are not limited to applying to an IBC block and can be used for the current block coded by any other mode (e.g. intra TMP or inter block). When the current block is coded with intra TMP, the reference block is found by template matching. When the current block is coded with inter mode, the reference block can be in a reference picture or a pre-defined picture, which is indicated with motion information of the current block and/or is pre-defined in the previously coded picture different from the current picture. For example, for the motion information of the current block being bi-prediction, the reference picture indicated by the reference index for list-0 and/or the reference picture indicated by the reference index for list-1 is used. For another example, for the motion information for the current block being uni-prediction, the reference picture indicated by the reference index for either list-0 or list-1 is used. If more than one reference picture is used, an order is used to define which reference picture is used first. One possible order is that the reference picture closer to the current picture (i.e., smaller POC) is used first. Another possible order is that the reference picture from a pre-defined list (list-0 or list-1) is used first.

In one embodiment, the representative prediction mode is derived based on mode information for any pre-defined subset of the prediction units (or coding block or any-pre-defined region) in the reference region (including the corresponding reference block and/or the neighbouring template of the corresponding reference block). The mode information includes mode types, intra prediction modes, motion information, block width, block height, block area, block shape, block ratio, residual information, transform information, partitioning information, and/or any subset/extension of the above.

In one sub-embodiment, if to find a representative prediction mode from the predefined subset of the prediction units fails, a default prediction mode is used as the representative prediction mode for the current block. The default prediction mode can be any available intra prediction mode such as planar or normal DIMD mode, which is always derived at the decoder.

In another sub-embodiment of the current block being coded by IBC, a reference block is indicated by the block vector and one or more mode information (e.g. intra prediction mode) saved in the reference block is used to derive the representative prediction mode for the current block. If the reference block is any one of special intra mode, and/or non-intra mode, a default intra prediction mode is used as the representative prediction mode; otherwise, the intra prediction mode for the reference block is used as the representative prediction mode for the current block.

In another sub-embodiment of the current block being coded by IBC, one or more prediction units in the reference region (may including the reference block and/or one or more prediction units spatially adjacent/non-adjacent to the reference blocks) are pre-defined and a scanning order is applied to the pre-defined prediction units. An example of the scanning order is shown as follows:
Selecting the intra prediction mode among the prediction units P1 to P5 follows a pre-defined order: P1, P2, P3, (P4, P5), where locations of P1-P5 are shown in FIG. 41.
   P1 covers the middle position in the reference block.
   P2 covers the right-bottom position in the reference block.
   P3 covers the left-above position in the reference block.
   P4 covers a pre-defined position (e.g. middle position) above-outer neighbouring the reference block.
   P5 covers a pre-defined position (e.g. middle position) left-outer neighbouring the reference block.
If the height of the block is greater than the width, P5 is checked prior to P4.
Otherwise, P4 is checked before P5.

Following the scanning order, an intra prediction mode among the pre-defined prediction units can be used as the representative prediction mode. For example, the first mode which has the intra prediction mode is used as the representative prediction mode. For another example, an explicit index is signalled/parsed to indicate an intra prediction mode among the pre-defined prediction units as the representative prediction mode. When the prediction unit in the pre-defined prediction units is not a valid mode, the invalid prediction unit is skipped during scanning or a default prediction mode is set for the invalid prediction unit. For example, non-intra (e.g. IBC), intra TMP, inter, and/or MIP, and/or any one mode mentioned in (Note D is not valid.

In another sub-embodiment of the current block being coded by IBC, one or more prediction units in the reference region (may including the reference block and/or one or more prediction units spatially adjacent/non-adjacent to the reference blocks) are pre-defined and a voting method is applied to the pre-defined prediction units. The voting method (e.g. majority method by counting) means to use the most popular prediction mode as the representative prediction mode for the current block. When the prediction unit in the pre-defined prediction units is not a valid mode, the invalid prediction unit is skipped for counting or a default prediction mode is set for the invalid prediction unit for counting. For example, non-intra (e.g. IBC), intra TMP, inter, and/or MIP, and/or any one mode mentioned in Note D is not valid.

In another embodiment, when the representative prediction mode (an intra prediction mode) is used to decide the transform kernel of MTS, the MTS can be implicit or explicit and the current block can be regular intra mode, special intra mode, non-intra mode and/or any one mode mentioned in Note D. The explicit MTS (such as Enhanced MTS for intra coding) means after selecting the MTS set for the current block, an MTS index is signalled to find one candidate (transform pair) from the MTS set. The implicit MTS means an implicit mapping rule (not depending on the syntax elements) is used to find the candidate. With the proposed methods, for explicit MTS, the selection of the MTS set depends on the representative prediction mode; for implicit MTS, the candidate is decided depending on the representative prediction mode (following a mapping rule). Tables 9-11 show examples of the mapping rule.

TABLE 9
Example 1 for mapping rule.

| Intra prediction mode | horizontal transform | vertical transform |
|---|---|---|
| Planar | DST-VII | DST-VII |
| Ang. 31, 32, 34, 36, 37 | | |
| DC | DCT-II | DCT-II |
| Ang. 33, 35 | | |
| Ang. 2, 4, 6 . . . 28, 30 | DST-VII | DCT-II |
| Ang. 39, 41, 43 . . . 63, 65 | | |
| Ang. 3, 5, 7 . . . 27, 29 | DCT-II | DST-VII |
| Ang. 38, 40, 42 . . . 64, 66 | | |

TABLE 10
Example 2 for mapping rule.

| Intra prediction mode | horizontal transform | vertical transform |
|---|---|---|
| Even | DCT-VIII | DCT-II |
| Odd | DCT-II | DST-VII |

TABLE 11
Example 3 for mapping rule.

| Intra prediction mode | horizontal transform | vertical transform |
|---|---|---|
| Even | DCT-II | DCT-VIII |
| Odd | DST-VII | DCT-II |

In another embodiment, the proposed methods can be used for colour format 4:4:4. The following shows an example. MIP can be used for chroma when the colour format is 4:4:4. For a chroma MIP block, the representative prediction mode can be used for the primary transform and/or secondary transform to select the transform set and/or the transpose flag.

In another embodiment, the representative prediction mode is stored in the buffer for intra prediction mode when the current block is coded with a special intra mode, non-intra mode and/or any one mode mentioned in Note D. In the subsequent process, if any process needs to access the buffer for intra prediction mode, the buffer for intra prediction mode is readily available.

In another embodiment, the representative prediction mode can implicitly vary with the block width, block height, block area or vary according to an explicit rule (e.g. syntax in block, tile, slice, picture, SPS, or PPS level). For example, one flag is signalled at the block level to indicate which proposed method is used to decide the transform set of the primary transform and/or secondary transform for the current block. If the flag indicates 1, the pre-defined process such as DIMD of the current block is performed within the current block to decide the transform set; otherwise (the flag indicates 0), the pre-defined process such as DIMD derived mode is performed on spatially neighbouring region of the current block to decide the transform set.

In another embodiment, any proposed methods or any combinations of the proposed methods can be applied to any intra modes, such as WAIP (wide-angle intra prediction), intra angular modes, ISP, MIP, or any intra mode specified in the VVC or HEVC or related art, or more developing modes in the following (referred as Note D in this disclosure):
SGPM
HOR/VER PL
   In JVET-AA0104 (Xinwei Li, et al., “Non-EE2: On planar horizontal mode and planar vertical mode”, Joint Video Exploration Team (JVET) of ITU-T SG 16 WP 3 and ISO/IEC JTC 1/SC 29/WG 11, 27th Meeting, by teleconference, 13-22 Jul. 2022, Document JVET-AA0104), for horizontal planar mode, only the horizontal linear interpolation is performed based on the left reference sample and the top-right reference sample to predict the current sample as:

$$pred ( x , y ) = ( ( W - 1 - x ) * rec ( - 1 , y ) + ( x + 1 ) * rec ( W , - 1 ) + ( W ≫ 1 ) ) ≫ {log}_{2} W$$

For vertical planar mode, only the vertical linear interpolation is performed based on the above reference sample and the bottom-left reference sample to predict the current sample as:

$$pred ( x , y ) = ( ( H - 1 - y ) * rec ( x , - 1 ) + ( y + 1 ) * rec ( - 1 , H ) + ( H ≫ 1 ) ) ≫ {log}_{2} H$$

When HOR/VER PL is used for the current block, decoder side derivation method is proposed to decide which of the two directional planar modes is used. Specifically, the horizontal gradient for each sample in the adjacent row of the current block and the vertical gradient for each sample in the adjacent column of the current block are calculated. If the sum of the absolute values of the horizontal gradients is greater than the sum of the absolute values of the vertical gradients, the vertical planar mode is used; otherwise, the horizontal planar mode is used.
Instead of directly using planar mode for the transform/inverse transform stage and/or the subsequent coding blocks, (1) the horizontal planar mode and vertical planar mode are modified into vertical mode and horizontal mode respectively or (2) any proposed methods in this invention. In another embodiment, the selection between (1) and (2) depends on block width/height/area. For example, if the block width/height/area is smaller than a predefined threshold (such as 2, 4, . . . or any pre-defined value), (1) is used; otherwise, (2) is used. For example, if the block width/height/area is larger than a predefined threshold (such as 2, 4, . . . or any pre-defined value), (1) is used; otherwise, (2) is used.
DBV (direct block vector): a chroma prediction mode
   Variation 1:
      A bin is signalled to indicate whether to use DBV mode or not
      When chroma dual tree is activated in intra slice, for a chroma CU coded as DBV mode, if one of the collocated luma blocks is coded with IBC mode or IntraTmp mode (intra Template Matching Prediction), its block vector bvL is used to derive chroma block vector bvC. The bv scaling process is determined according to template matching.
      By using the position of the current chroma block at (xCb, yCb) and its bvC, the corresponding offset position (xCb+bvC[0], yCb+bvC[1]) is determined, and a block copy prediction is performed.
   Variation 2:
      When chroma dual tree is activated in intra slice, for a chroma CU coded as DM mode, a pre-defined collocated luma blocks is coded with IBC mode or IntraTMP mode, its block vector bvL is used to derive chroma block vector bvC. The bv scaling process is determined according to template matching.
   By using the position of the current chroma block at (xCb, yCb) and its bvC, the corresponding offset position (xCb+bvC[0], yCb+bvC[1]) is determined, and a block copy prediction is performed.
   Instead of using planar mode for the transform/inverse transform stage and/or the subsequent coding blocks, (1) chroma DM or (2) any proposed methods in this invention. In another embodiment, the selection between (1) and (2) depends on block width/height/area. For example, if the block width/height/area is smaller than a predefined threshold (such as 2, 4, . . . or any pre-defined value), (1) is used; otherwise, (2) is used. For example, if the block width/height/area is larger than a predefined threshold (such as 2, 4, . . . or any pre-defined value), (1) is used; otherwise, (2) is used.
Mixed modes (e.g. CIIP/GPM)

In another embodiment, to reduce the latency caused by the proposed methods of determining the representative prediction mode for the current block, at the encoder, when performing primary transform, the proposed methods are used to decide the prediction mode for vertical transform only (not for horizontal transform); at the decoder, the proposed methods are used to decide the prediction mode for vertical inverse transform only (not for horizontal inverse transform).

In another embodiment, to reduce the latency caused by the proposed methods of determining the representative prediction mode for the current block, at the encoder, when performing primary transform, the proposed methods are used to decide the prediction mode for horizontal transform only (not for vertical transform); at the decoder, the proposed methods are used to decide the prediction mode for horizontal inverse transform only (not for vertical inverse transform).

In another embodiment, to reduce the latency caused by the proposed methods of determining the representative prediction mode for the current block, the proposed methods are only used to determine the prediction mode for separable transform coding (e.g. primary transform) and is not used for non-separate transform (e.g. secondary transform).

In another embodiment, to reduce the latency caused by the proposed methods of determining the representative prediction mode for the current block, the proposed methods are not used to determine the prediction mode for secondary transform.

In another embodiment, to reduce the latency caused by the proposed methods of determining the representative prediction mode for the current block, some enabling conditions are designed for the proposed methods and the proposed methods are allowed only when the enabling conditions are satisfied.

In one sub-embodiment, the enabling conditions include a mode setting. A mode setting means that the mode of the current block is checked first and the proposed methods cannot be applied if the mode of the current block belongs to a complex mode. For example, the complex mode refers to a blending mode with the final predictors being formed by multiple hypothesis of predictions. A blending mode may be a CIIP/GPM/MHP/TIMD/DIMD coded mode. For another example, the complex mode refers to a refining mode with the motion/predictors being refined with multiple passes or with decoder-side derivation. A refining mode may be a DMVR/intra TMP coded mode.

In another sub-embodiment, the enabling conditions include a size setting related to block width, block height, or block area, or block shape. A size setting means that the size of the current block is checked first and the proposed methods cannot be applied if the size of the current block is not hardware friendly or not good for the DIMD to calculate histogram or the TIMD to calculate the cost. For example, when the width or height for the current block is larger than a pre-defined threshold, the proposed method cannot be used. For another example, when the width or height of the current block is smaller than a pre-defined threshold, the proposed method cannot be used. For another example, if the area of the current block is larger than a pre-defined threshold, the proposed method cannot be used. For another example, if the area of the current block is smaller than a pre-defined threshold, the proposed method cannot be used. For another example, if the longer side of the current block is much larger than the shorter side of the current block, the proposed method cannot be used. The pre-defined threshold can be any integer such as 2, 4, 8, 16, . . . , or any pre-defined value. When the proposed methods cannot be used, the default way is used to decide the representative prediction mode.

In another embodiment, to reduce the latency caused by the proposed methods of determining the representative prediction mode for the current block, some pre-processing operations are designed for the proposed methods and the proposed methods are applied after the pre-processing operations.

In another sub-embodiment, the pre-processing operations include a block setting. For example, the block setting refers to sub-sampling (e.g. down-sampling) the used predicted/reconstructed samples (within the current block and/or the spatially neighbouring region of the current block and/or the reference region for the current block) first and then applying the proposed methods to the sub-sampled samples. For another example, the block setting refers to only applying the proposed methods to the subset of the used predicted/reconstructed samples (within the current block and/or the spatially neighbouring region of the current block and/or the reference region for the current block). The subset of the used samples may be the first N rows or columns of the used samples, where N can be any pre-defined integer such as 4, 8, 16, etc. The subset may be the first M samples in the used samples, where M can be any pre-defined integer such as 4, 8, 16, etc.

In another sub-embodiment, the pre-processing operations include a splitting setting. The splitting setting refers to dividing the used predicted/reconstructed samples (within the current block and/or the spatially neighbouring region of the current block and/or the reference region for the current block) into K subblocks and the proposed methods are applied to each subblock individually where K can be any pre-defined integer such as 4, 16, etc.

The proposed methods in this invention can be enabled and/or disabled according to implicit rules (e.g. block width, height, or area) or according to explicit rules (e.g. syntax on block, tile, slice, picture, SPS, or PPS level). For example, the proposed method is applied when the block area is smaller/larger than a threshold.

The term “block” in this invention can refer to TU/TB, CU/CB, PU/PB, pre-defined region, or CTU/CTB.

Any combination of the proposed methods in this invention can be applied.

The following is an example for chroma to use the proposed mechanism by allowing more primary transform candidates. Assuming that N MTS candidates (used in intra MTS) are supported for chroma, where N is set as 6, 4, 2, or 1. When the enabling conditions are satisfied, each chroma TB can signal an index to select its mtsIdx (mtsIdxCb and mtsIdxCr). The enabling condition for more primary transform candidates may include:
Enabling condition (1): The current CU is intra with chroma components
Enabling condition (2): 4<=chroma width<T and 4<=chroma height<T
   T is set as 32, 64, 128, or maximum TB size in the standard
Enabling condition (3): For a chroma TB, allow MTS only when there are AC significant coefficients or there are significant coefficients in a pre-defined region
   The position of the last significant coefficient is larger than 0 (DC position)
   The position of the last significant coefficient is larger than any pre-defined value
   When JCCR is used, only the coded TB will signal an mtsIdx
   When “any one of mtsIdxCb and mtsIdxCr”>0, LFNST is disabled

For each chroma TB, if mtsIdx==0, use DCT2 as original; otherwise, use MTS as additional transform options.

In one embodiment, the N candidates are selected from the transform candidate set in Note C.

In another embodiment, the N MTS candidates for chroma (inherited from luma) can be determined as follows:
If luma is not MTS, a transform candidate is set as the MTS candidate for chroma
   The transform candidate is determined by chroma TB size as implicit intra MTS

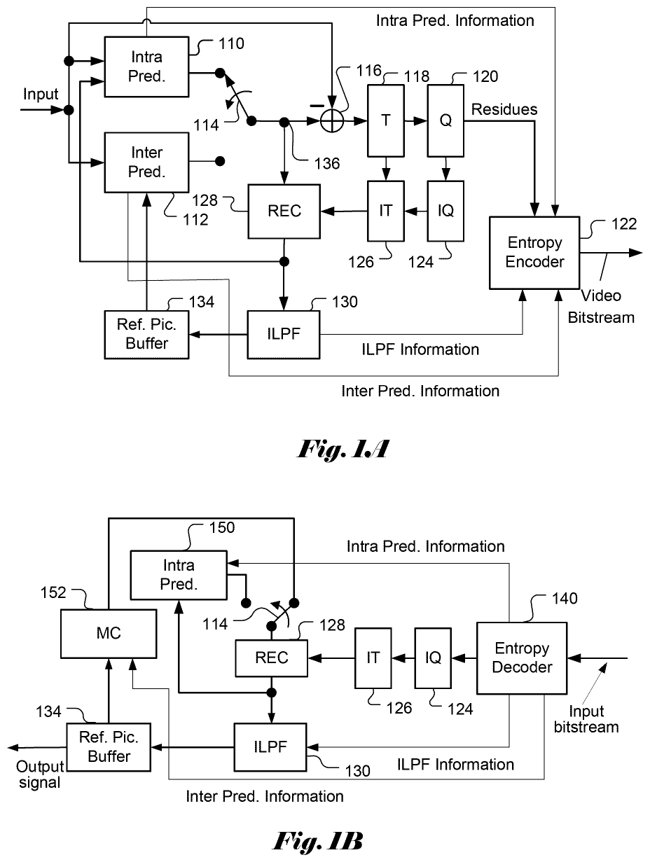

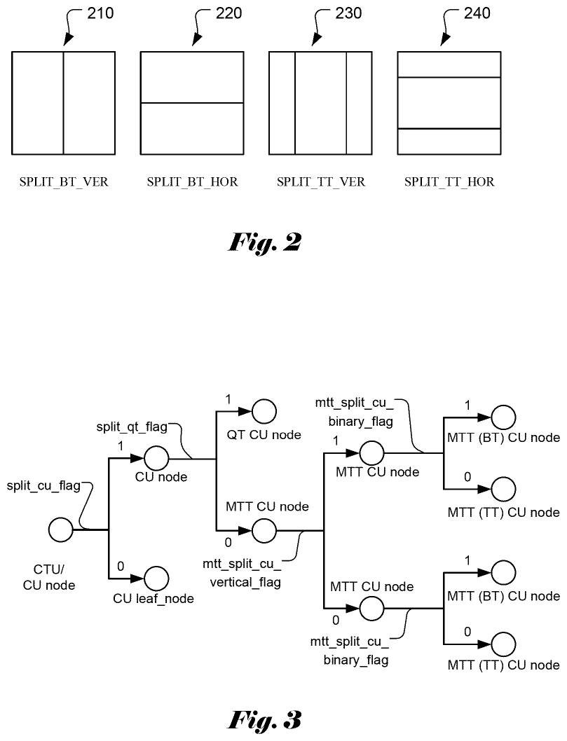

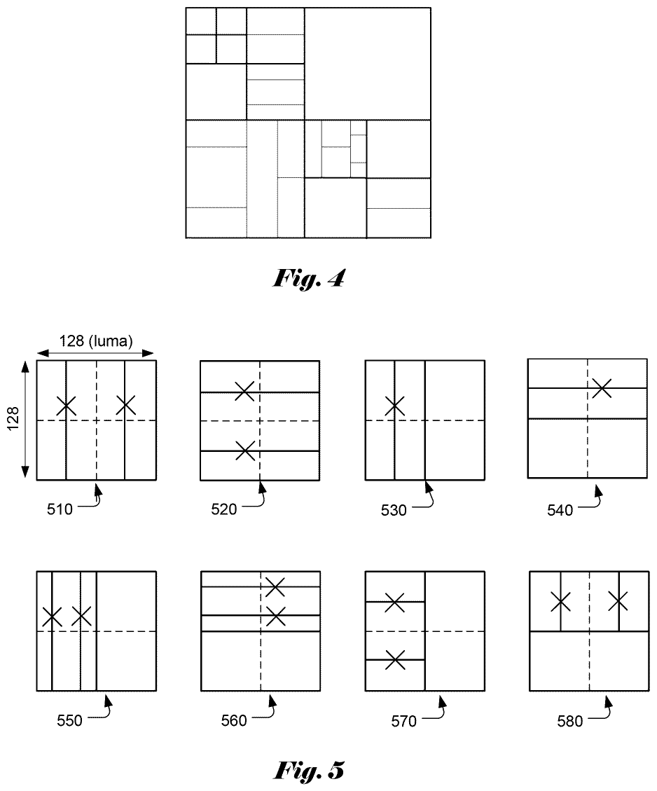

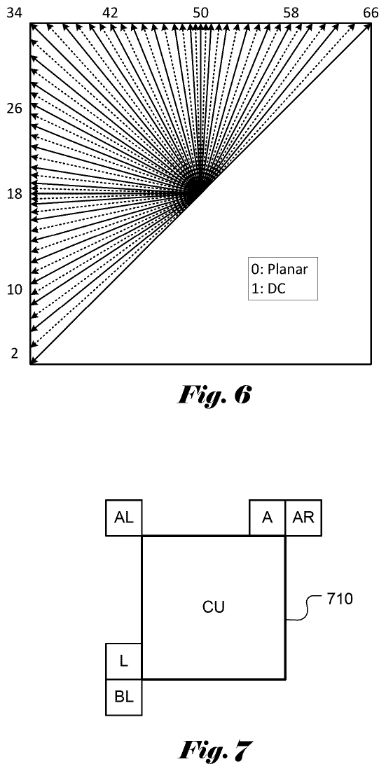

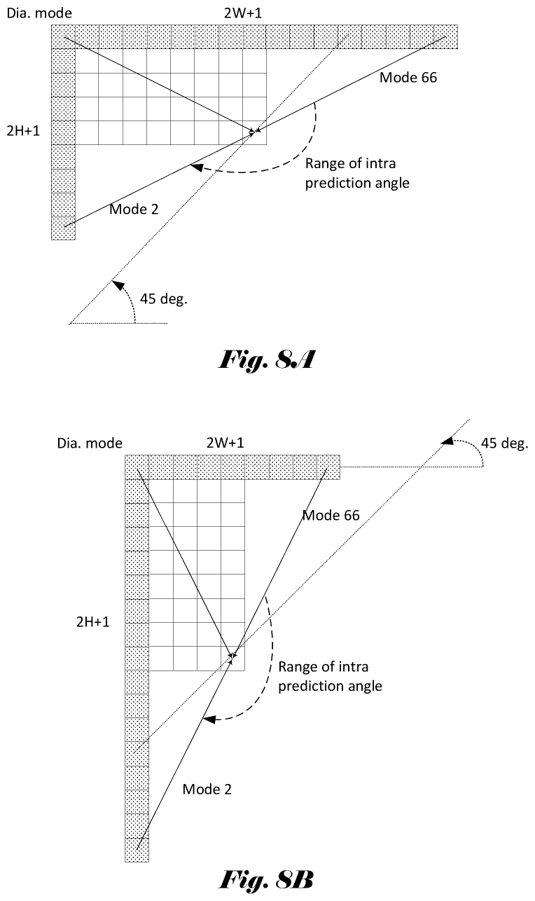

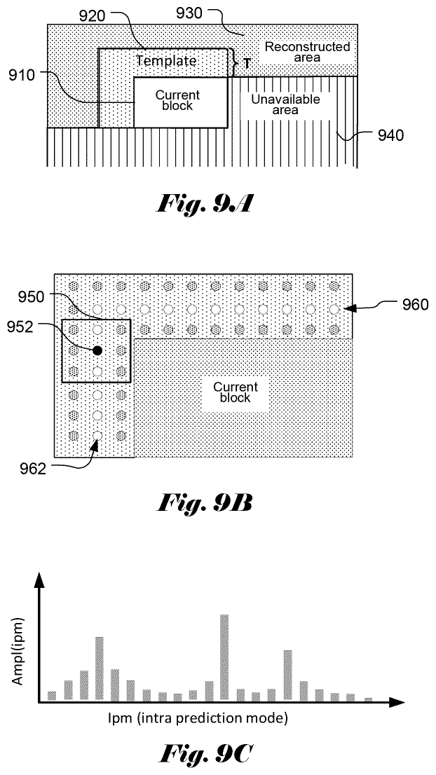

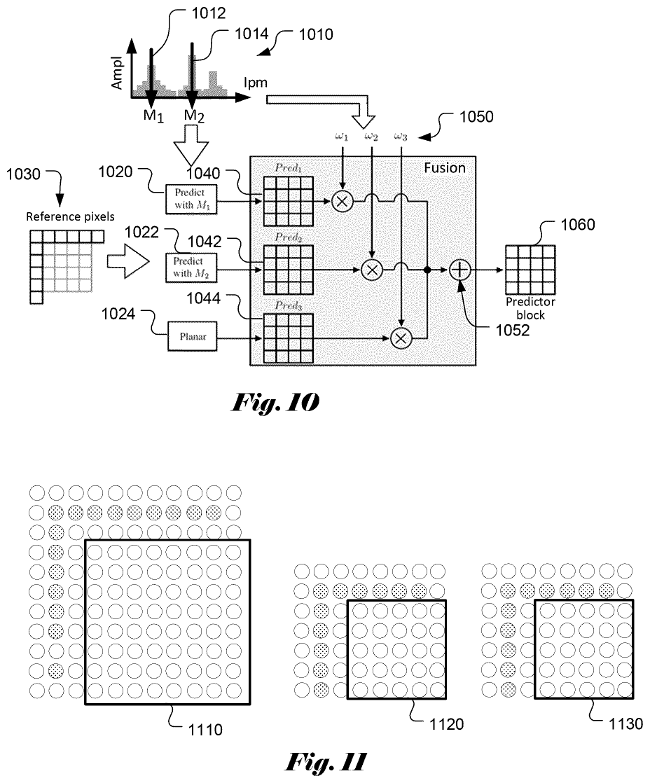

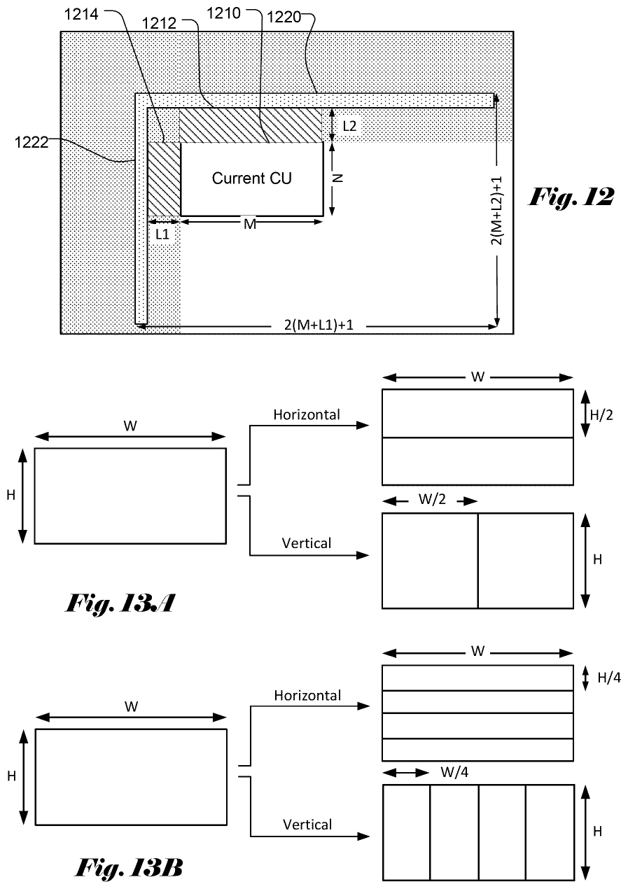

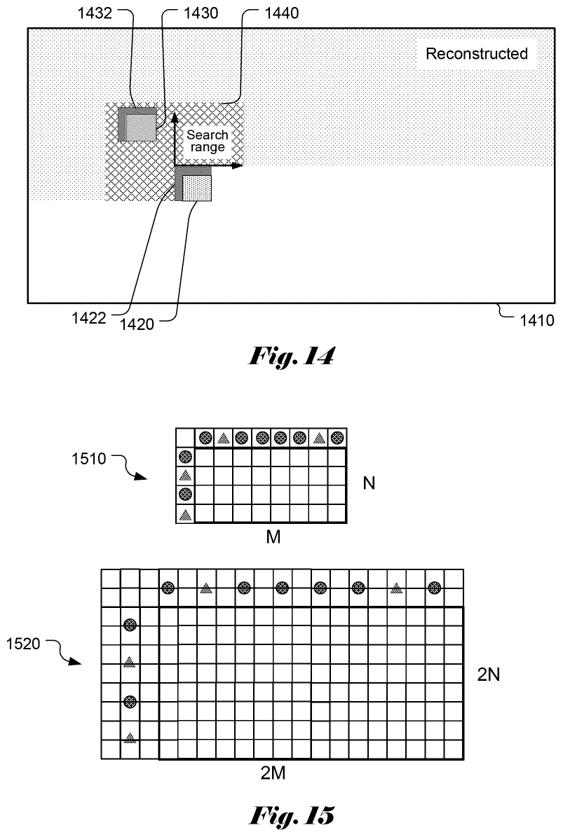

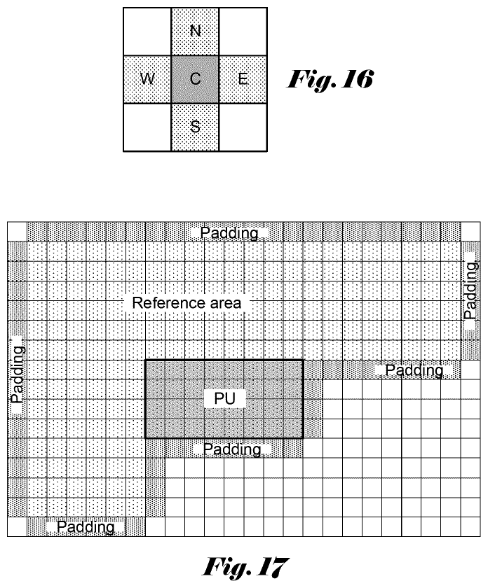

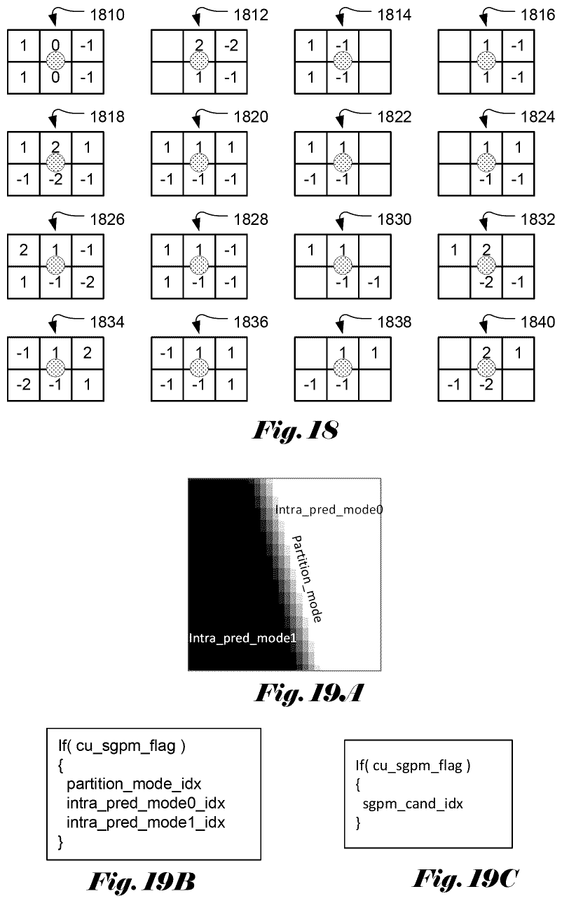

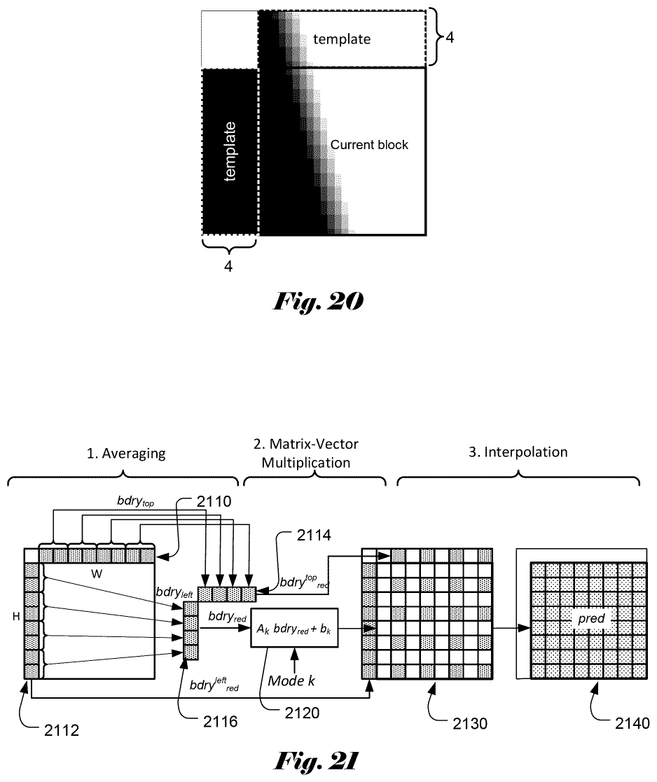

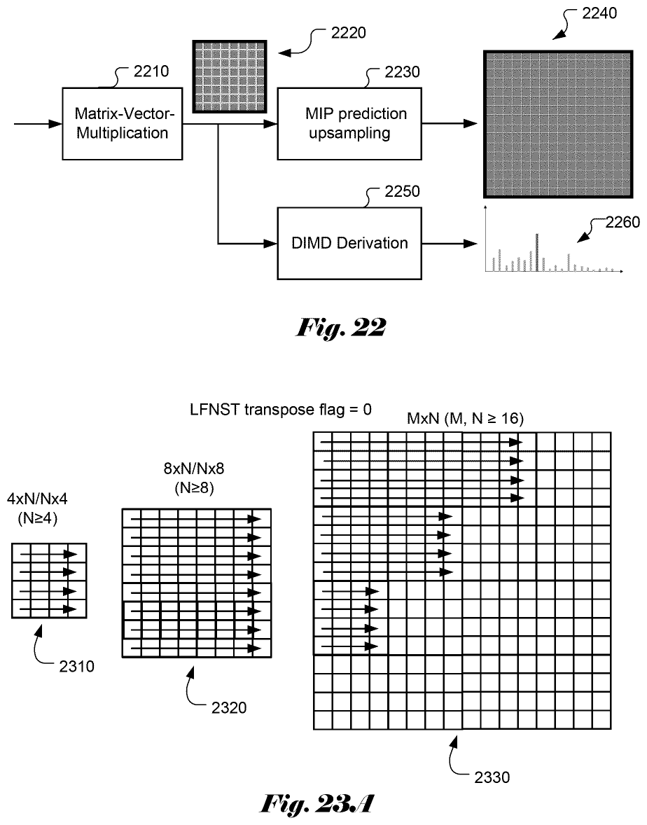

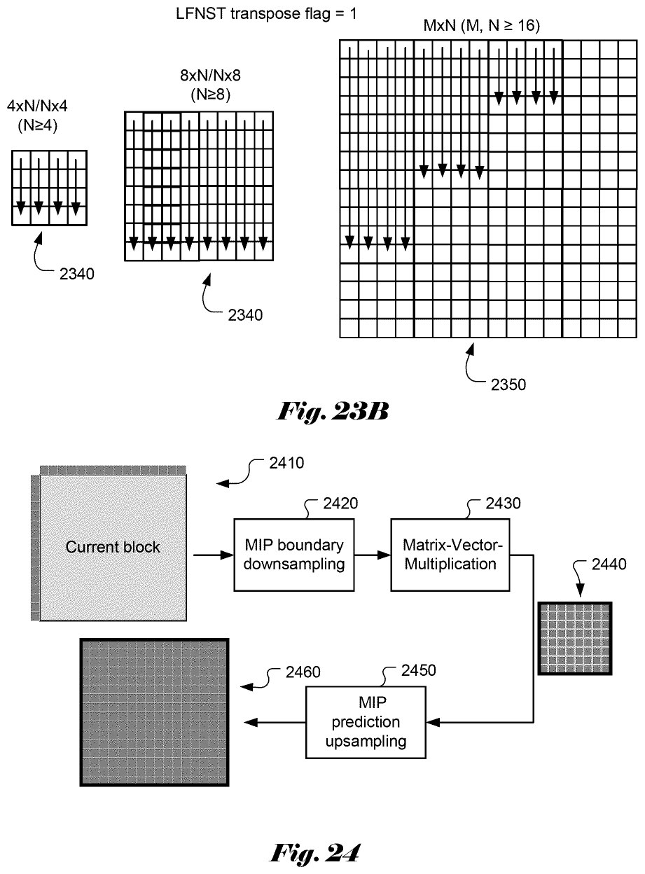

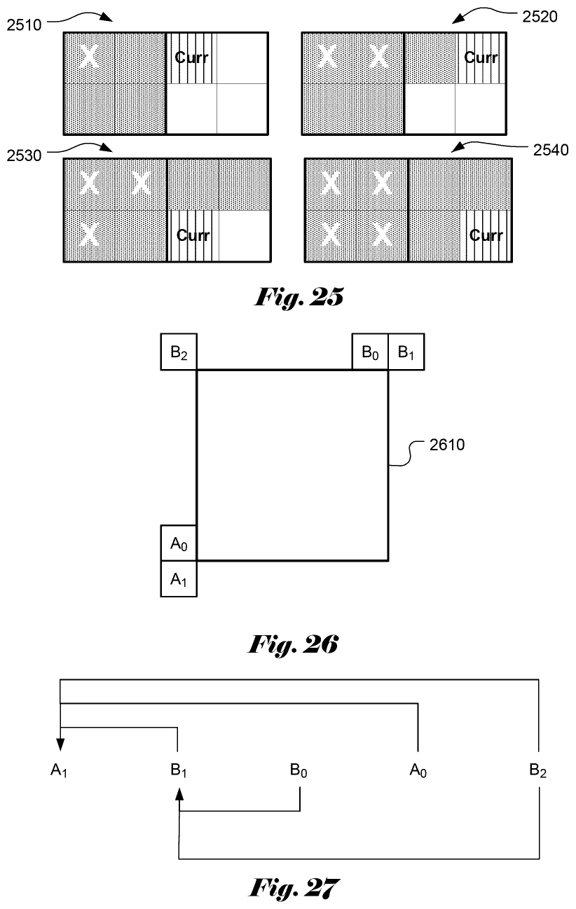

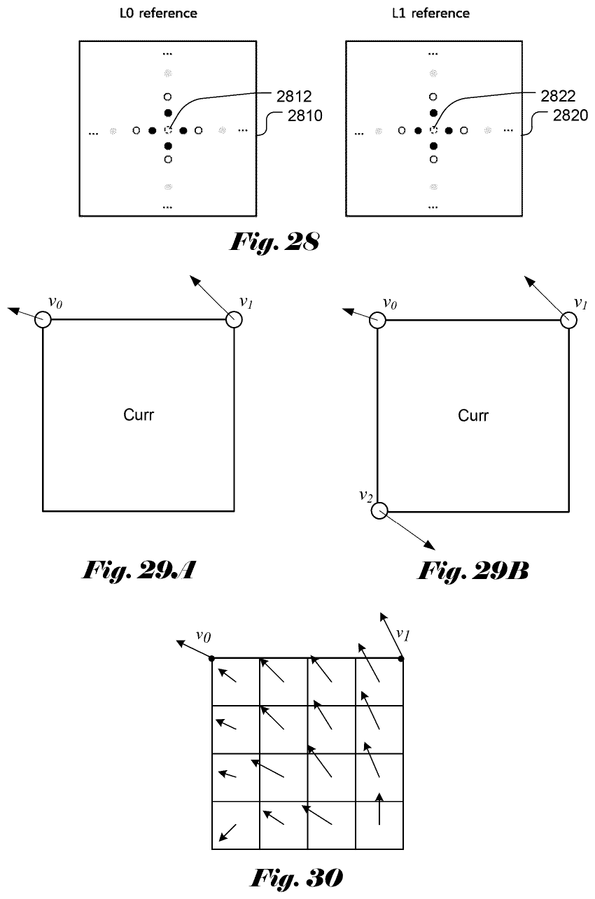

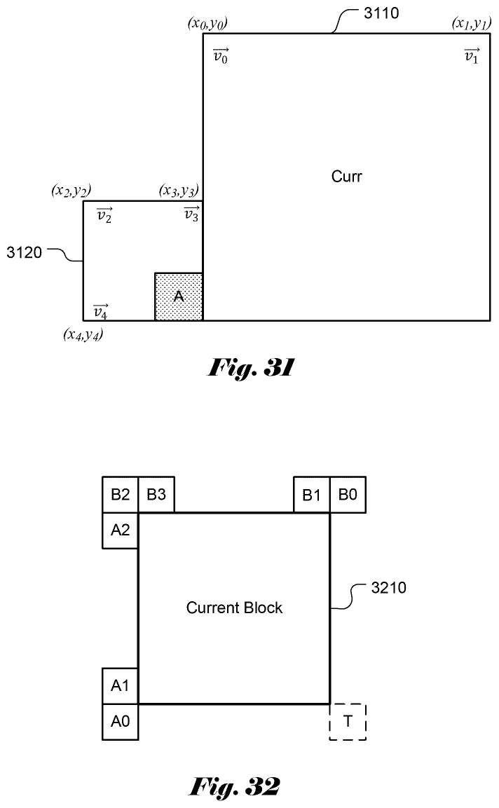

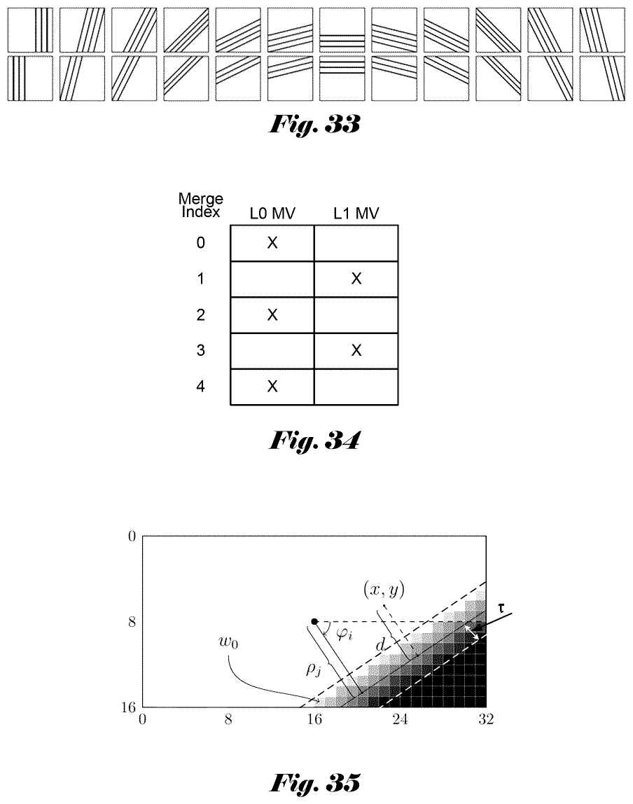

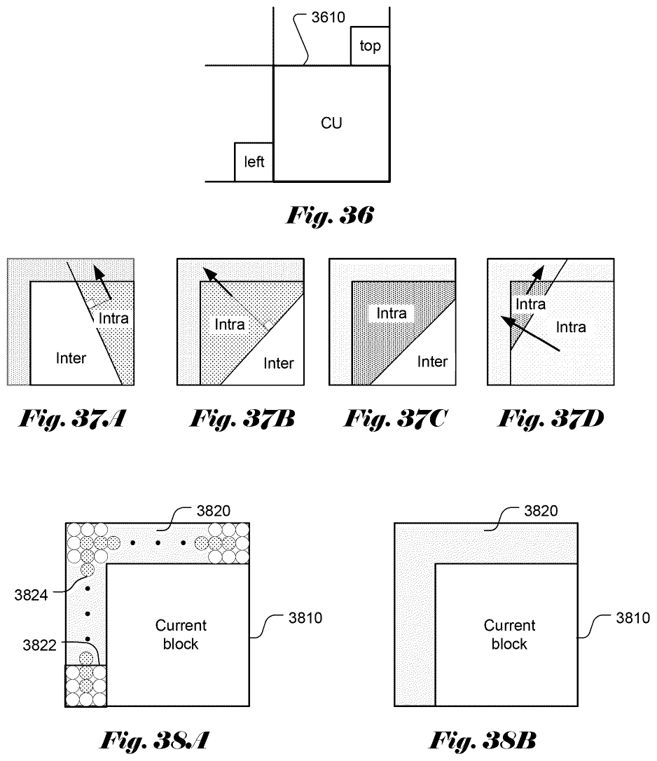

Any of the foregoing proposed improved transform process methods can be implemented in encoders and/or decoders. For example, any of the proposed methods can be implemented in an inter/intra/IBC/prediction/transform module of an encoder, and/or an inter/intra/IBC/prediction/transform module of a decoder. Alternatively, any of the proposed methods can be implemented as a circuit coupled to the inter/intra/IBC/prediction/transform module of the encoder and/or the inter/intra/IBC/prediction/transform module of the decoder, so as to provide the information needed by the inter/intra/IBC/prediction/transform module. With reference to the encoder and decoder in FIG. 1A and FIG. 1B, any of the proposed methods can be implemented in an inter/intra/prediction/transform module (e.g. Intra Pred. 110 in FIG. 1A) of an encoder, and/or an inter/intra/prediction/transform module (e.g. Intra Pred. 150 in FIG. 1B) of a decoder.

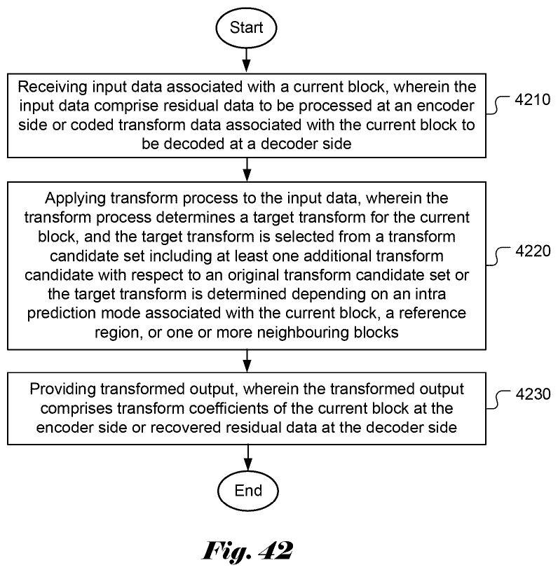

FIG. 42 illustrates a flowchart of an exemplary video coding system that incorporates improved transform process according to an embodiment of the present invention. The steps shown in the flowchart may be implemented as program codes executable on one or more processors (e.g., one or more CPUs) at the encoder side and/or decoder side. The steps shown in the flowchart may also be implemented based hardware such as one or more electronic devices or processors arranged to perform the steps in the flowchart. According to this method, input data associated with a current block are received in step 4210, wherein the input data comprise residual data to be processed at an encoder side or coded transform data associated with the current block to be decoded at a decoder side. Transform process is applied to the input data in step 4220, wherein the transform process determines a target transform for the current block, and the target transform is selected from a transform candidate set including at least one additional transform candidate with respect to an original transform candidate set or the target transform is determined depending on an intra prediction mode associated with the current block, a reference region, or one or more neighbouring blocks. Transformed output is provided in step 4230, wherein the transformed output comprises transform coefficients of the current block at the encoder side or recovered residual data at the decoder side.

The flowchart shown is intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video coding, the method comprising:
receiving input data associated with a current block, wherein the input data comprise residual data to be processed at an encoder side or coded transform data associated with the current block to be decoded at a decoder side;
applying transform process to the input data, wherein the transform process determines a target transform for the current block, and the target transform is selected from a transform candidate set including at least one additional transform candidate with respect to an original transform candidate set or the target transform is determined depending on an intra prediction mode associated with the current block, a reference region, or one or more neighbouring blocks; and
providing transformed output, wherein the transformed output comprises transform coefficients of the current block at the encoder side or recovered residual data at the decoder side.

2. The method of claim 1, wherein the transform process comprises a primary transform at the encoder side or the transform process comprises an inverse primary transform at the decoder side, and wherein the transform process comprises a secondary transform at the encoder side or the transform process comprises an inverse secondary transform at the decoder side.

3. The method of claim 2, wherein the target transform corresponds to a separable or non-separable primary transform or secondary transform.

4. The method of claim 1, wherein the current block is coded using IntraTMP (intra Template Matching Prediction) mode, MIP (Matrix weighted Intra Prediction) mode, SGPM (Spatial Geometric Partitioning Mode), DBV (Direct Block Vector), or horizontal/vertical planar mode.

5. The method of claim 1, wherein the current block is coded using a cross-component mode.

6. The method of claim 1, wherein the current block is coded using an inter, intra or IBC mode.

7. The method of claim 1, wherein the current block corresponds to a luma block or a chroma block.

8. (canceled)

9. (canceled)

10. (canceled)

11. The method of claim 1, wherein the original transform candidate set consists of DCT-II and said at least one additional transform candidate corresponds to one or more MTS (Multi Transform Selection) candidates.

12. The method of claim 11, wherein an on/off control is used at a block level to determine whether to use said at least one additional transform candidate for the current block.

13. (canceled)

14. (canceled)

15. (canceled)

16. The method of claim 1, wherein when the current block uses JCCR (Joint Coding of Chroma Residuals) mode, Cr and Cb components of the current block share a same transform selection.

17. (canceled)

18. (canceled)

19. (canceled)

20. The method of claim 1, wherein the target transform is determined depending on the intra prediction mode derived based on a decoder side derivation technique or a template-based derivation technique on the current block or said one or more neighbouring blocks.

21. The method of claim 1, wherein the target transform is determined depending on the intra prediction mode indicated by a block vector or a motion vector.

22. The method of claim 1, wherein the intra prediction mode is derived based on mode information in the reference region including a corresponding reference block and/or a neighbouring region of the corresponding reference block.

23. The method of claim 1, wherein the target transform is determined depending on the intra prediction mode derived based on a derivation technique, and wherein the derivation technique varies according to block width of the current block, block height of the current block, block area of the current block, or an explicit syntax of the current block.

24. An apparatus for video coding, the apparatus comprising one or more electronics or processors arranged to:
receive input data associated with a current block, wherein the input data comprise residual data to be processed at an encoder side or coded transform data associated with the current block to be decoded at a decoder side;
apply transform process to the input data, wherein the transform process determines a target transform for the current block, and the target transform is selected from a transform candidate set including at least one additional transform candidate with respect to an original transform candidate set or the target transform is determined depending on an intra prediction mode associated with the current block, a reference region, or one or more neighbouring blocks; and
provide transformed output, wherein the transformed output comprises transform coefficients of the current block at the encoder side or recovered residual data at the decoder side.
